(19) United States
(12) Patent Application Publication
(10) Pub. No.: US 2023/0408285 A1
(43) Pub. Date: Dec. 21, 2023

(54) LANE DETERMINATION APPARATUS, LANE-CHANGE DETERMINATION PROGRAM, AND DATA STRUCTURE

(71) Applicant: DENSO CORPORATION, Kariya-city (JP)

(72) Inventor: Tomoo NOMURA, Kariya-city (JP)

(21) Appl. No.: 18/459,973

(22) Filed: Sep. 1, 2023

Related U.S. Application Data
(63) Continuation of application No. PCT/JP2022/007261, filed on Feb. 22, 2022.

(30) Foreign Application Priority Data
Mar. 5, 2021 (JP) 2021-035379

(51) Int. Cl. G01C 21/36; B60W 30/14; B60W 50/14; B60W 30/12; B60W 30/18; B60W 60/00

(52) U.S. Cl. CPC G01C 21/3658; B60W 30/143; B60W 50/14; B60W 30/12; B60W 30/18163; B60W 60/001; B60W 2050/146; B60W 2530/00; B60W 2552/53; B60W 2552/10

(57) ABSTRACT

In a lane keeping apparatus, a first retrieving unit retrieves, for each lane, a continuously travelable distance. The continuously travelable distance for each lane represents a distance for which an own vehicle is able to travel while keeping the corresponding lane. A first identifying unit identifies a road, as a traveling road, on which the own vehicle is traveling, and one of the lanes, as a traveling lane, in which the own vehicle is traveling. A first determiner compares a continuously travelable own-lane distance with at least one continuously travelable other-lane distance to accordingly determine whether lane change from the traveling lane to at least one other lane included in the lanes is suitable.

### REFERENCE TO RELATED APPLICATIONS

This application is a bypass continuation application of currently pending international application No. PCT/JP2022/007261 filed on Feb. 22, 2022 designating the United States of America, the entire disclosure of which is incorporated herein by reference, the international application being based on and claims the benefit of priority from Japanese Patent Application No. 2021-035379 filed on Mar. 5, 2021, the disclosure of which is incorporated in its entirety herein by reference.

### TECHNICAL FIELD

The present disclosure relates to lane determination apparatuses, lane-change determination programs, and data structures.

### BACKGROUND OF THE INVENTION

The lane keeping function of keeping an own vehicle in its lane, i.e., the traveling lane, is widely available for vehicles. Specifically, the lane keeping function performs speed control and/or steering control of an own vehicle to accordingly cause the own vehicle to travel in the traveling lane while automatically keeping the own vehicle in the center of the traveling lane without driver's driving operations. The lane keeping function aims to reduce driver's burden.

For example, Japanese Patent Publication NO. 4745877 discloses an inventive configuration that recognizes, based on forward images captured by a camera installed in an own vehicle, left and right lane markers of a traveling lane included in a road, and calculates a left-side distance between the left lane marker line and the own vehicle in the width direction of the own vehicle and a right-side distance between the right lane marker and the own vehicle in the width direction of the own vehicle. Then, the inventive configuration keeps the own vehicle in the traveling lane in accordance with the calculated left-side distance and the right-side distance.

### SUMMARY OF THE INVENTION

The inventive configuration disclosed in the patent publication can keep, in theory, the own vehicle in a traveling lane as long as (i) the left and right lane markers of the traveling lane are present, and (ii) the left and right lane markers are recognizable from the forward images.

Unfortunately, some geometries of a forward portion of the road may make it difficult to recognize the left and right lane markers.

Let us consider a first example geometry of the forward portion of the road, which reduces or increases the number of lanes in the forward portion of the road as compared with the number of lanes in a current own-vehicle's location of the road. The first example geometry of the forward portion of the road may make it difficult for the own vehicle to recognize the left and right lane markers of a traveling lane of the own vehicle, resulting in the lane keeping function being terminated. This termination of the lane keeping function may make it difficult to keep the own vehicle in the traveling lane.

Let us consider a second example geometry of the forward portion of the road, which causes a traveling lane of the own vehicle to join an undesired lane different from a driver's desired lane. Although the second example geometry of the forward portion of the road makes it possible for the own vehicle to continuously recognize the left and right lane markers of the undesired lane to accordingly perform the lane keeping function, the second example geometry of the forward portion of the road may result in the own vehicle moving in the undesired lane, which is different from the driver's desired lane.

The present disclosure therefore aims to determine, based on a geometry of a forward portion of a traveling road, which of lanes an own vehicle should travel in.

In an exemplary measure of the present disclosure, a first retrieving unit is configured to retrieve, for each of a plurality of lanes, a continuously travelable distance. The continuously travelable distance for each of the lanes represents a distance for which an own vehicle is able to travel while keeping to the corresponding one of the lanes. A first identifying unit is configured to identify a road, as a traveling road, in which the own vehicle is traveling, and one of the lanes, as a traveling lane, in which the own vehicle is traveling. A first determiner is configured to compare a continuously travelable own-lane distance with at least one continuously travelable other-lane distance to accordingly determine whether lane change from the traveling lane to at least one other lane included in the plurality of lanes is suitable. The continuously travelable own-lane distance is the continuously travelable distance of the traveling lane of the own vehicle, and the at least one continuously travelable other-lane distance is the continuously travelable distance of the at least one other lane. An output unit is configured to output information indicative of whether lane change from the traveling lane to the at least one other lane is suitable.

The exemplary measure of the present disclosure compares the continuously travelable distance of the traveling lane of the own vehicle with the continuously travelable distance of the at least one other lane to accordingly determine whether lane change from the traveling lane to the at least one other lane is suitable, and outputs a result of the determination of whether lane change from the traveling lane to the at least one other lane is suitable.

Specifically, upon determining that lane change from the traveling lane to the at least one other lane is suitable, the exemplary measure of the present disclosure outputs the result of the determination that lane change from the traveling lane to the at least one other lane is suitable. This therefore enables suitable determination of a lane in which the own vehicle will travel, making it possible to issue a notification that prompts the driver of the own vehicle to perform a lane change operation from the traveling lane to the at least one other lane, and/or instruct a cruise control system to perform an autonomous-driving control task of such lane change. The lane change of the own vehicle from the traveling lane to a selected other lane included in the at least one other lane enables the selected other lane to be maintained as a traveling lane for the own vehicle, making it possible to suitably select any of lanes in a traveling road as a traveling lane in accordance with the configuration of the traveling road.

### BRIEF DESCRIPTION OF THE DRAWINGS

The above object, other objects, characteristics, and advantageous benefits of the present disclosure will become apparent from the following description with reference to the accompanying drawings in which:

FIG. 1 is a functional block diagram illustrating an overall configuration of a lane keeping apparatus according to an exemplary embodiment of the present disclosure;

FIG. 2 is a first table illustrating a corresponding lane data set;

FIG. 3 is a second table illustrating a corresponding lane data set;

FIG. 4 is a third table illustrating a corresponding lane data set;

FIG. 5 is a view illustrating a first road configuration in which the number of lanes decreases;

FIG. 6 is a diagram illustrating road numbers, road segment numbers, and lane numbers for the first road configuration;

FIG. 7 is a diagram illustrating continuously travelable distances for the first road configuration;

FIG. 8 is a view illustrating a second road configuration in which the destination of a traveling lane is changed;

FIG. 9 is a diagram illustrating road numbers, road segment numbers, and lane numbers for the second road configuration;

FIG. 10 is a diagram illustrating continuously travelable distances for the second road configuration;

FIG. 11 is a view illustrating a third road configuration in which the number of lanes increases;

FIG. 12 is a diagram illustrating road numbers, road segment numbers, and lane numbers for the third road configuration;

FIG. 13 is a diagram illustrating continuously travelable distances for the third road configuration;

FIG. 14 is a first flowchart;

FIG. 15 is a view illustrating an icon for prompting a lane change operation;

FIG. 16 is a diagram used to describe operations for the first road configuration in which the number of lanes decreases;

FIG. 17 is a diagram used to describe the operations for the first road configuration in which the number of lanes decreases;

FIG. 18 is a diagram used to describe the operations for the first road configuration in which the number of lanes decreases;

FIG. 19 is a diagram used to describe operations for the second road configuration in which the destination of the traveling lane is changed;

FIG. 20 is a diagram used to describe the operations for the second road configuration in which the destination of the traveling lane is changed;

FIG. 21 is a diagram used to describe operations for the second road configuration in which the destination of the traveling lane is changed;

FIG. 22 is a diagram used to describe operations for the third road configuration in which the number of lanes increases;

FIG. 23 is a diagram used to describe the operations for the third road configuration in which the number of lanes increases;

FIG. 24 is a diagram used to describe the operations for the third road configuration in which the number of lanes increases;

FIG. 25 is a diagram illustrating a first example operation that prevents prompting of a lane change operation to a driver;

FIG. 26 is a diagram illustrating a second example operation that prevents prompting of a lane change operation to the driver;

FIG. 27 is a diagram illustrating a third example operation that prevents prompting of a lane change operation to the driver;

FIG. 28 is a diagram illustrating lanes that fall into a category of intersection straight-through lanes;

FIG. 29 is a diagram illustrating lanes that do not fall into the category of intersection straight-through lanes;

FIG. 30 is a diagram illustrating a selected data region;

FIG. 31 is a diagram used to describe operations that dynamically set continuously travelable distances;

FIG. 32 is a diagram used to describe operations that dynamically set continuously travelable distances;

FIG. 33 is a diagram used to describe operations that dynamically set the continuously travelable distances;

FIG. 34 is a diagram used to describe operations that dynamically set the continuously travelable distances;

FIG. 35 is a second flowchart;

FIG. 36 is a third flowchart;

FIG. 37 is a fourth flowchart;

FIG. 38 is a fifth flowchart;

FIG. 39 is a sixth flowchart;

FIG. 40 is a seventh flowchart;

FIG. 41 is a table used to describe operations that identify a lane change destination;

FIG. 42 is a table used to describe the operations that identify the lane change destination; and

FIG. 43 is a table used to describe the operations that identify the lane change destination.

### DETAILED DESCRIPTION

The following describes an exemplary embodiment of the present disclosure with reference to the accompanying drawings.

A vehicle, i.e., an own vehicle, in which a lane keeping control apparatus 1 is installed, includes an autonomous driving function, and is configured to travel in a switchable one of (i) an autonomous driving mode based on the autonomous driving function and (ii) a manual driving mode based on driver's manual driving operations.

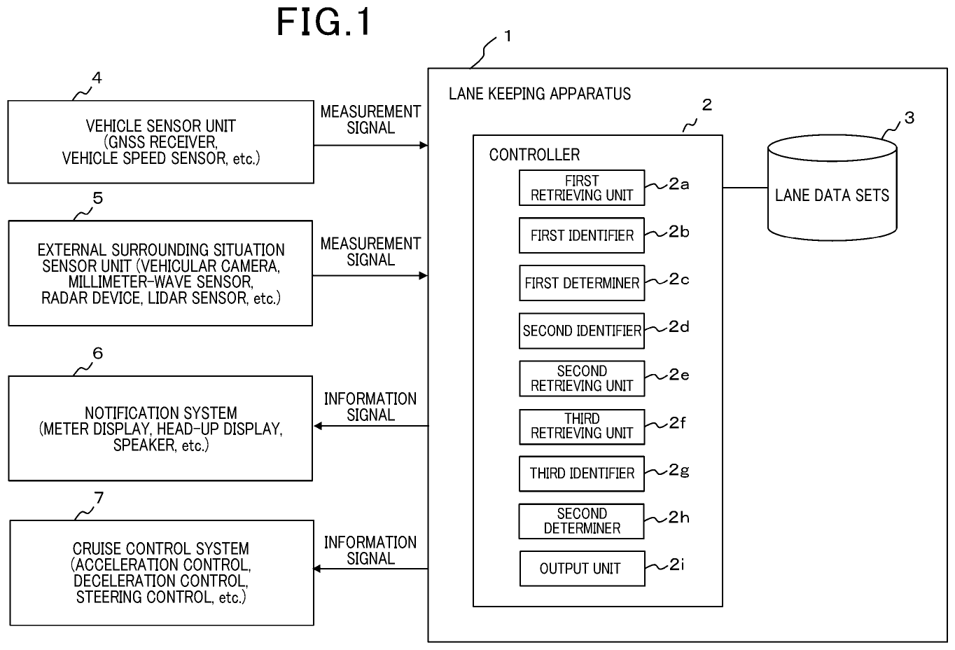

The lane keeping control apparatus 1 includes, as illustrated in FIG. 1, a controller 2 and a lane data storage unit 3.

The controller 2 includes a microcomputer that is comprised of a central processing unit (CPU), a read only memory (ROM), a random-access memory (RAM), and input/output (I/O) interface. The microcomputer is configured to run one or more computer programs stored in at least one of non-transitory tangible storage media to accordingly perform one or more tasks corresponding to the one or more computer programs. Execution of the one or more tasks enable control of overall operations of the lane keeping control apparatus 1.

The lane keeping control apparatus 1 can be configured to operate in cooperation with, for example, a cruise assist system; the cruise assist system includes, for example, a collision avoidance apparatus, for ensuring safe and secure traveling of the own vehicle. A lane keeping function of the lane keeping control apparatus 1 is one of cruise assist functions installed in the own vehicle. The lane keeping control apparatus 1 includes, in addition to the lane keeping control function, a lane determination function. The lane determination function is to determine whether it is suitable for the own vehicle to execute change of a traveling lane of the own vehicle to another lane. The lane keeping control apparatus 1 serves as a lane determination apparatus.

A vehicle position sensor unit 4 includes, for example, a global navigation satellite system (GNSS) receiver and a vehicle speed sensor. The vehicle position detector 4 is configured to receive GNSS signals sent from GNSS satellites, and calculate, based on the received GNSS signals, GNSS positional coordinates. Then, the vehicle position sensor unit 4 is configured to complement the GNSS positional coordinates based on a speed of the own vehicle measured by the vehicle speed sensor to accordingly measure a current position of the own vehicle. The vehicle position sensor unit 4 is additionally configured to transmit, to the lane keeping control apparatus 1, measurement signals including the measured current position of the own vehicle. The GNSS is a general term describing various satellite positioning systems, such as GPS, GLONASS, Galileo, BeiDou, and/or IRNSS.

The vehicle position detector 4 can include an acceleration sensor and/or a gyro sensor, and can be configured to complement the GNSS positional coordinates based on an acceleration of the own vehicle measured by the acceleration sensor and/or the rate of change in at least one direction defined for the own vehicle.

An external surrounding situation sensor unit 5 includes, for example, one or more vehicular cameras, one or more millimeter-wave sensors, one or more radar devices, and one or more lidar (Light Imaging Detection and Ranging) sensors. The one or more vehicular cameras capture one or more images showing the surroundings of the own vehicle, and the one or more millimeter-wave sensors measure environments around the own vehicle. Additionally, the one or more radar devices measure the environments around the own vehicle, and the one or more lidar sensors measure the environments around the own vehicle.

The external surrounding situation sensor unit 5 is configured to determine, based on the captured images and the measured environments, an environmental situation around the own vehicle. Then, the external surrounding situation sensor unit 5 is configured to output, to the lane keeping apparatus 1, measurement signals including the environmental situation, i.e., an external situation, around the own vehicle.

The environmental situation around the own vehicle, which is measured by the external surrounding situation sensor unit 5, can include information about both edges of a traveling road on which the own vehicle is traveling, and information indicative of lane markers at least one lane of the traveling road.

The external surrounding situation sensor unit 5 can be comprised of only one or more vehicular cameras, and can be comprised of at least one of one or more vehicular cameras, one or more millimeter-wave sensors, and one or more radar devices.

The lane data storage unit 3 stores lane data sets corresponding to respective roads. The lane data storage unit 3 and one or more other computer resources can share at least one of the hardware storage media. The lane data storage unit 3 can be comprised of, as a main component, at least one non-transitory tangible storage medium provided independently for storing data about traffic lanes.

The lane data storage unit 3 can be configured to include lane data sets about relatively wide roads, and/or include lane data sets about relatively narrow roads.

Specifically, the lane data storage unit 3 can be configured to be in cooperation with one or more external servers that manage lane data sets included in many regions. Lane data sets about, for example, relatively narrow roads included in one or more necessary regions are downloaded from the one or more external serves through one or more communication networks, and thereafter are temporarily stored in the lane data storage unit 3.

The controller 2 can be configured to select one of a storage mode and a streaming mode.

The storage mode is to load lane data sets from the lane data storage unit 3 without communications with the external servers.

The streaming mode is to
(I) Communicate with the one or more external servers, download lane data sets from the one or more external servers to accordingly store the lane data sets temporarily in the lane data storage unit 3
(II) Read the lane data sets from the lane data storage unit 3

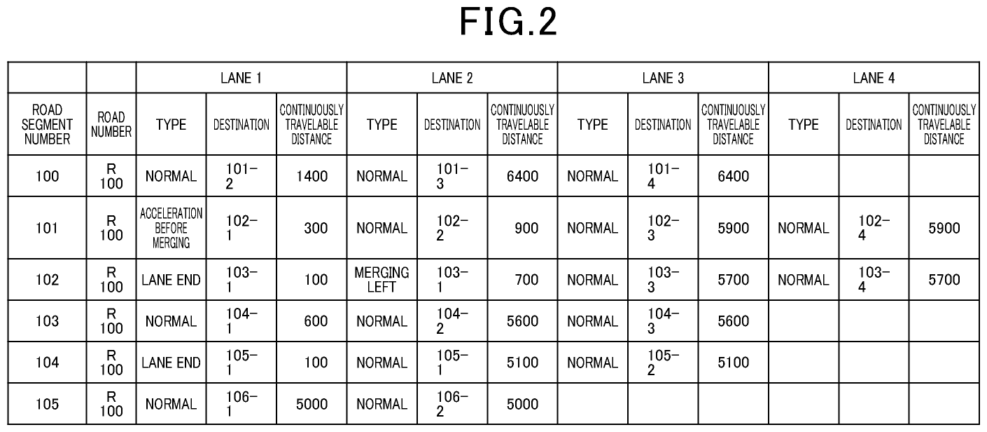

The lane data set for each road is comprised of a data item of at least one lane included in the corresponding road. The lane data set for each road is, as illustrated in FIGS. 2 to 4, comprised of
(i) A road number, i.e., a number of the corresponding road, as road identification information
(ii) A road segment number indicative of respective segments into which the corresponding road are partitioned
(iii) A lane number of the at least one lane included in the corresponding road as lane identification information
(iv) A type of the at least one lane included in the corresponding road
(v) A destination of the at least one lane included in the corresponding road
(vi) A continuously travelable distance for the at least one lane included in each road segment of the corresponding road

In summary, the lane data item for the at least one lane has a predetermined data structure comprised of a continuously travelable distance defined to correlate with the corresponding road number and the corresponding lane number.

The following describes the meaning of each component of the lane data set for each road.

The road number of the corresponding road is a predetermined unique number given to the corresponding road, which substantially has the same meaning as the name of the corresponding road.

If a selected road whose name is changed in middle thereof, the road number of the selected road can be determined to be kept unchanged as long as the selected road is determined to be a continuously travelable road.

For example, let us consider the Tomei Expressway that is a national expressway in Japan between Tokyo and Komaki, and the Meishin Expressway in Japan between Komaki and Nishinomiya, so that the Tomei Expressway is connected to the Meishin Express way via Komaki in the real world. If a vehicle travels from the direction of Tokyo to the direction of Nishinomiya via Komaki, or a vehicle travels from the direction of Nishinomiya to the direction of Tokyo via Komaki, the vehicle can continuously travel on a selected lane without lane changes. This makes it possible to determine that the combination of Tomei Expressway and Meishin Expressway is a continuously travelable road.

Otherwise, even for a selected road whose name is kept unchanged, the road number of one section of the selected road may be determined to be changed from the road number of another section of the selected road as long as the selected road is not determined to be a continuously travelable road.

That is, in Japan, there are many roads, each of which has a predetermined unique road number and one or more intersections. In each of the intersections of any road, right and/or left turns of a vehicle can be carried out, and each of the intersections of any road may have one or more branches. For these reasons, even if a selected road has a predetermined unique number and one or more intersections, the selected road cannot be determined to be a continuously travelable road, so that the selected road can be determined as separate roads.

In the lane data set for each road, the road number of the corresponding road can correlate with positional information on a region, i.e., a road region, of the corresponding road; positional coordinates of the region of the corresponding road enable the region of the corresponding road to be identified.

The road segment number for each segment of the corresponding road is a unique number given to the corresponding segment of the corresponding road. The segments of any road are defined such that vehicle-travel situations in one of any adjacent pair of segments of the road and vehicle-travel situations in the other of the adjacent pair of segments of the road are different from one another.

If no lanes are in one of any adjacent pair of segments of any road and one or more lanes appear in the other of the adjacent pair of segments of the road, the vehicle-travel situations in the other of the adjacent pair of segments of the road are determined to be changed from the vehicle-travel situations in the one of the adjacent pair of segments of the road.

If one or more lanes are in one of any adjacent pair of segments of any road and the one or more lanes disappear in the other of the adjacent pair of segments of the road, the vehicle-travel situations in the other of the adjacent pair of segments of the road are determined to be changed from the vehicle-travel situations in the one of the adjacent pair of segments of the road.

If one or more lane markers in one of any adjacent pair of segments of any road are changed to one or more lane markers in the other of the adjacent pair of segments of the road, the vehicle-travel situations in the other of the adjacent pair of segments of the road are determined to be changed from the vehicle-travel situations in the one of the adjacent pair of segments of the road.

Any segment in which one or more lanes newly appear as compared with the adjacent segment in which no lanes appear will be referred to as a lane appearing segment or a lane start segment. Similarly, any segment in which one or more lanes have disappeared as compared with the adjacent segment in which one or more lanes are will be referred to as a lane disappearing segment or a lane end segment.

The lane number of the at least one lane included in the corresponding road is predetermined a unique number given to the at least one lane. In each of FIGS. 2 to 4, “LANE 1”, “LANE 2”, “LANE 3”, and “LANE 4” are respectively illustrated as the lane numbers. The lane number of each lane can correlate with positional information on a region of the corresponding lane; positional coordinates for the region of each lane enable the region of the corresponding lane to be identified.

The continuously travelable distance for each lane included in each segment of the corresponding road represents a distance for which any vehicle is able to travel while keeping the corresponding lane. The continuously travelable distance for each lane included in each segment can be calculated based on the sum of the distance of the corresponding segment and the continuously travelable distance of a destination lane for the corresponding segment.

In particular, if one of the following first to third conditions is satisfied for any segment, the continuously travelable distance for the corresponding segment is set to 0.

The first condition for any segment is that the road number of the segment is different from the road number of the destination for the segment.

The second condition for any segment is that there is no destination for the segment, i.e., the lane of the segment is ended.

The third condition for any segment is that there are several destinations for the segment, so that it cannot determine any of the several destinations.

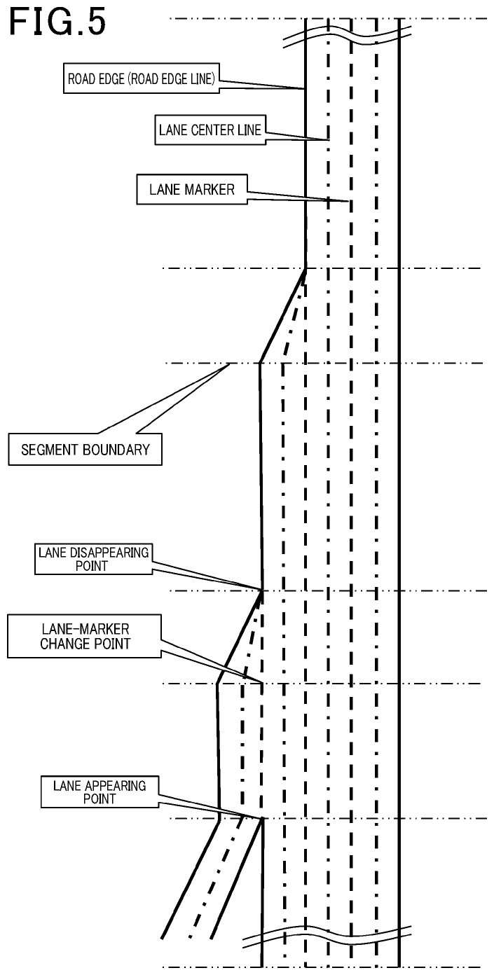

The lane data set illustrated in FIG. 2 is a lane data set for a road illustrated in FIG. 5; the road illustrated in FIG. 5 is configured such that the number of lanes decreases in the forward direction of the own vehicle.

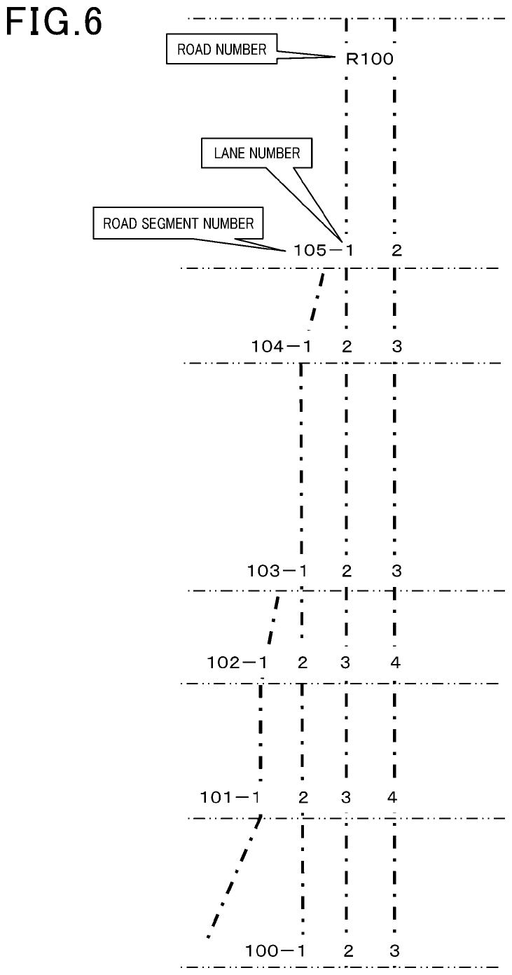

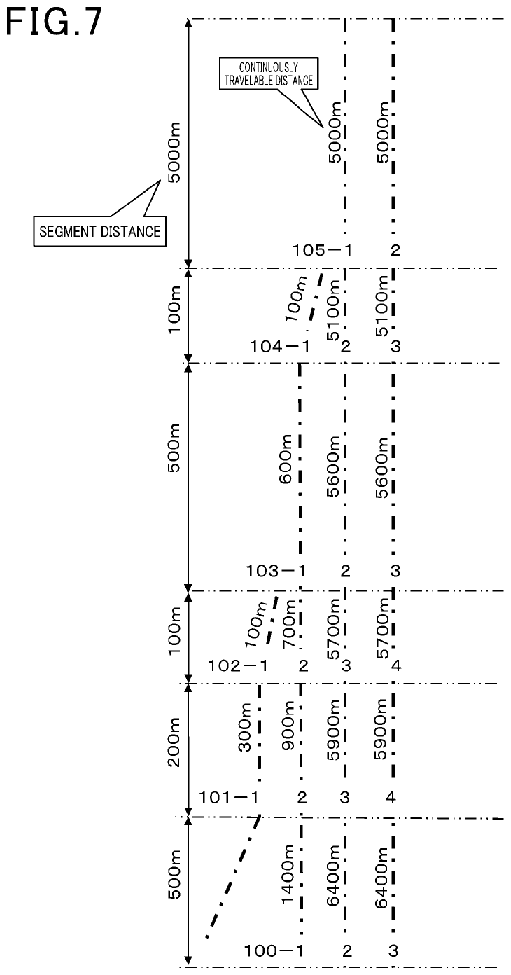

The lane data set illustrated in FIG. 2 for such a road configuration illustrated in FIG. 5 includes (I) a road number (R100), road segment numbers (100, 101, 102, 103, 104, 105), and lane numbers (1, 2, 3, 4) illustrated in FIG. 6, and (II) continuously travelable distances, such as 6400 m and 5600 m, for the respective lanes in each segment (100, 101, 102, 103, 104, 105) illustrated in FIG. 7.

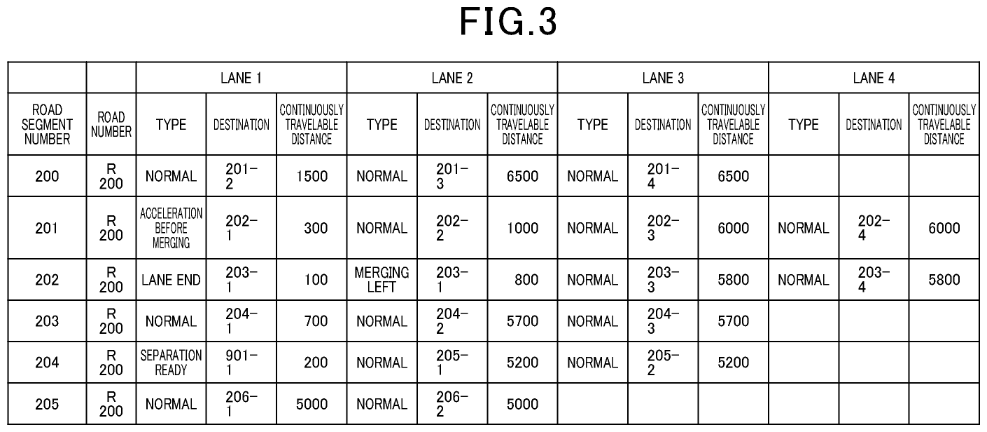

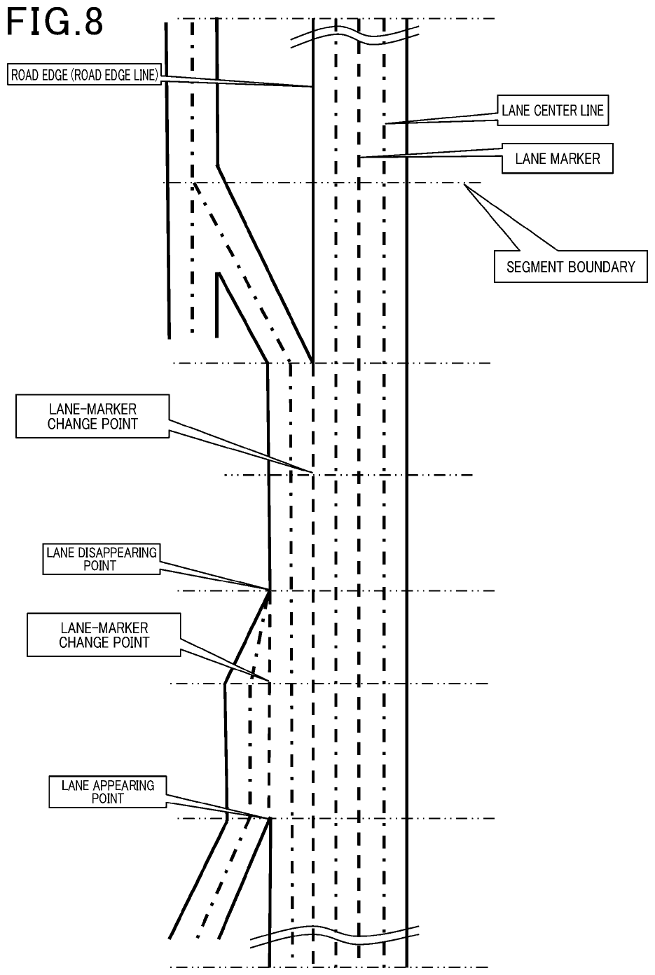

Similarly, the lane data set illustrated in FIG. 3 is a lane data set for a road illustrated in FIG. 8; the road illustrated in FIG. 8 is configured such that the destination of a traveling lane of the own vehicle is changed in the forward direction of the own vehicle.

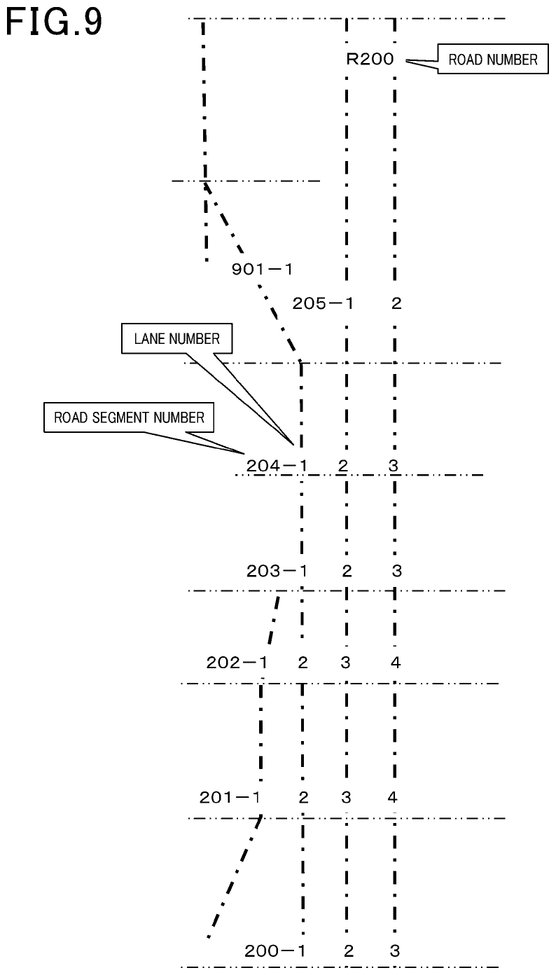

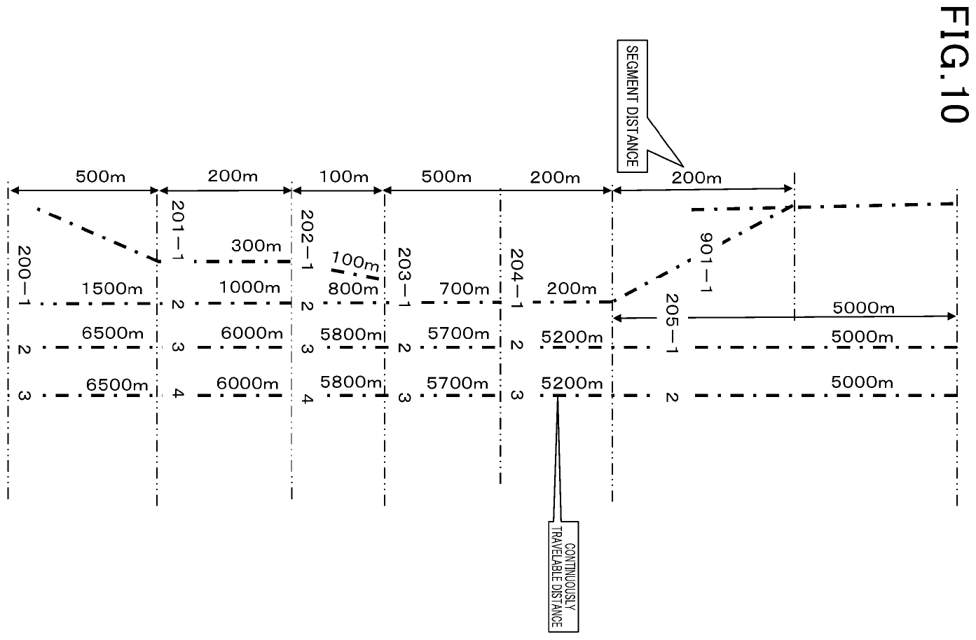

The lane data set illustrated in FIG. 3 for such a road configuration illustrated in FIG. 8 includes (I) a road number (R200), road segment numbers (200, 201, 202, 203, 204, 205), and lane numbers (1, 2, 3, 4) illustrated in FIG. 9, and (II) continuously travelable distances, such as 6000 m and 5800 m, for the respective lanes in each segment (200, 201, 202, 203, 204, 205) illustrated in FIG. 10.

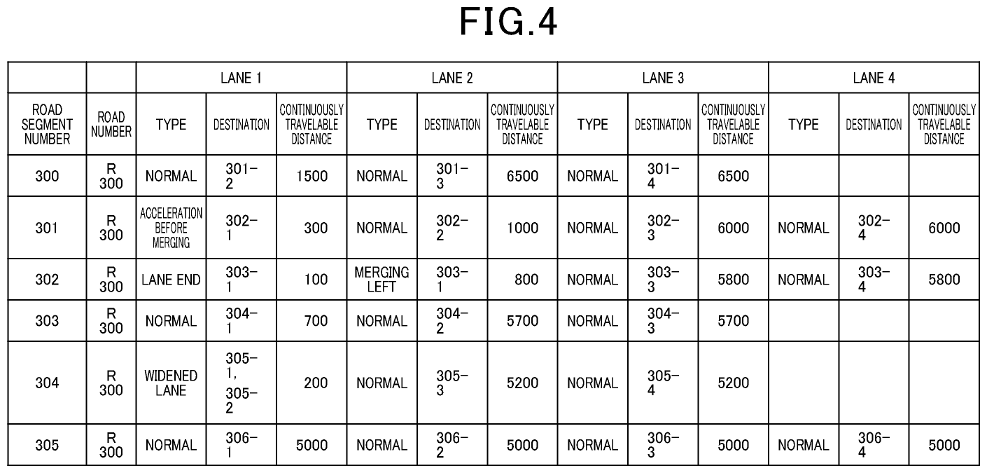

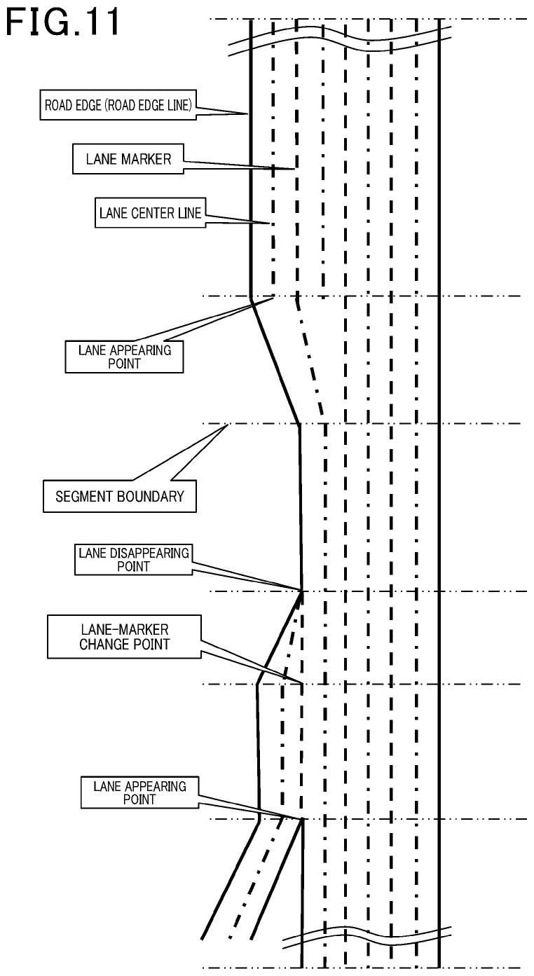

Additionally, the lane data set illustrated in FIG. 4 is a lane data set for a road illustrated in FIG. 11; the road illustrated in FIG. 11 is configured such that the number of lanes increases in the forward direction of the own vehicle.

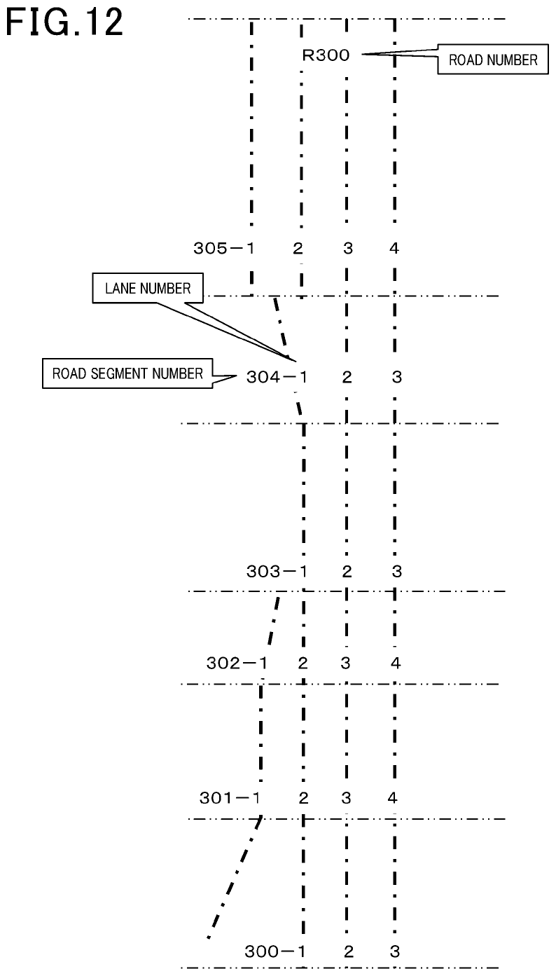

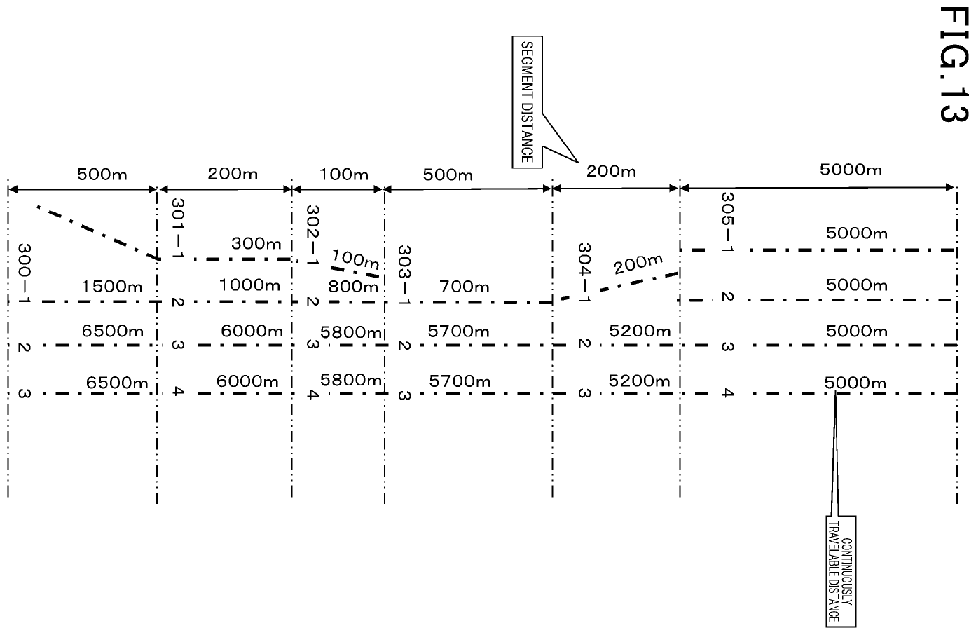

The lane data set illustrated in FIG. 4 for such a road configuration illustrated in FIG. 11 includes (I) a road number (R300), road segment numbers (300, 301, 302, 303, 304, 305), and lane numbers (1, 2, 3, 4) illustrated in FIG. 12, and (II) continuously travelable distances, such as 5700 m and 5200 m, for the respective lanes in each segment (300, 301, 302, 303, 304, 305) illustrated in FIG. 13.

In each of FIGS. 5, 8, and 11, lane center lines are illustrated. Each lane center line is a virtual line located between a corresponding road edge or a corresponding road edge line, and a corresponding lane marker or between a corresponding adjacent pair of lane markers. That is, the lane center line for each lane is a line virtually generated at the center of the corresponding lane through which vehicles travel normally.

The controller 2 includes a first retrieving unit 2a, a first identifying unit 2b, a first determiner 2c, a second identifying unit 2d, a second retrieving unit 2e, a third retrieving unit 2f, a third identifying unit 2g, a second determiner 2h, and an output unit 2i. These units 2a to 2i serve as respective functions that are implemented by execution of a lane-change determination program. That is, the controller 2 is configured to execute the lane-change determination program to accordingly perform the above functions 2a to 2i.

The second identifying unit 2d identifies the current position of the own vehicle based on the measurement signals inputted from the vehicle position sensor unit 4.

The second retrieving unit 2e loads, from the lane data storage unit 3, the lane data sets, and refers to the lane data sets loaded from the lane data storage unit 3 to accordingly check the identified current position of the own vehicle against the road regions, each of which is represented by the positional coordinates that correlate with the corresponding road number of the corresponding road. Then, the second retrieving unit 2a retrieves, from the lane data sets, the road number corresponding to the current position of the own vehicle. That is, the second retrieving unit 2e retrieves the road number of a road that has the region containing the current position of the own vehicle.

The third retrieving unit 2f refers to the lane data sets loaded from the lane data storage unit 3 to accordingly check the identified current position of the own vehicle against the lane regions, each of which is represented by the positional coordinates that correlate with the corresponding lane number of the corresponding road. Then, the third retrieving unit 2a retrieves, from the lane data sets, the road number corresponding to the current position of the own vehicle. That is, the third retrieving unit 2f retrieves the lane number of a lane that has the region containing the current position of the own vehicle.

The third identifying unit 2g identifies the environmental situation around the own vehicle in accordance with the measurement signals inputted from the external surrounding situation sensor to accordingly identify the environmental situation around the own vehicle.

The first identifying unit 2b identifies a traveling road and a traveling lane on which the own vehicle is traveling in accordance with
(I) The road number retrieved by the second retrieving unit 2e
(II) The lane number retrieved by the third retrieving unit 2f
(III) The environmental situation identified by the third identifying unit 2g

The first retrieving unit 2a retrieves, from the continuously travelable distances included in the lane data sets loaded from the lane data storage unit 3, the continuously travelable distances corresponding to the respective traveling road and traveling lane.

The second determiner 2h determines whether the road number of the traveling road of the own vehicle has changed to another road number to accordingly determine whether road change has occurred. Additionally, the second determiner 2h determines whether the lane number of the traveling lane of the own vehicle has changed to another lane number to accordingly determine whether lane change has occurred.

In response to determining that the road number of the traveling road of the own vehicle has changed to another road number, the second determiner 2h determines that road change has occurred. Additionally, in response to determining that the lane number of the traveling lane of the own vehicle has changed to another lane number, the second determiner 2h determines that lane change has occurred.

The first determiner 2c performs a comparison between (i) the continuously travelable distance of the traveling lane of the own vehicle and (ii) a continuously travelable distance of at least one other lane that extends in parallel to the traveling lane of the own vehicle. The continuously travelable distance of the traveling lane of the own vehicle will be referred to as a continuously travelable own-lane distance, and the continuously travelable distance of the at least one other lane will be referred to as a continuously travelable other-lane distance.

Then, the first determiner 2c determines, based on the comparison result, whether change of the traveling lane of the own vehicle to the at least one other lane is suitable. The at least one other lane has the same meaning as at least one parallel lane.

Specifically, let us consider a region where the traffic regulations define that drivers keep to the left side of the road. In this region, if the own vehicle travels the left-side lane of a two-lane section in each way, the right-side lane of the two-lane section is determined as the at least one other lane. Similarly, in this region, if the own vehicle travels the left-side lane of a three-lane section in each way, the center lane and the right-side lane of the three-lane section can be determined as the at least one other lane.

In response to determining, based on the comparison result, that the continuously travelable other-lane distance is longer than the continuously travelable own-lane distance, the first determiner 2c calculates a deviation distance that represents the deviation of the continuously travelable other-lane distance from the continuously travelable own-lane distance. Then, the first determiner 2c compares the calculated deviation distance with a predetermined threshold distance to accordingly determine whether the calculated deviation distance is longer than the threshold distance. In response to determining that the calculated deviation distance is longer than the threshold distance, the first determiner 2c determines that change of the traveling lane of the own vehicle to a selected other lane included in the at least one other lane is suitable.

Otherwise, in response to determining that the continuously travelable other-lane distance is smaller than or equal to the continuously travelable own-lane distance, the first determiner 2c determines that change of the traveling lane of the own vehicle to the at least one other lane is unsuitable. Additionally, even if determining that the continuously travelable other-lane distance is longer than the continuously travelable own-lane distance, in response to determining that the calculated deviation distance is smaller than or equal to the threshold distance, the first determiner 2c determines that change of the traveling lane of the own vehicle to the at least one other lane is unsuitable.

Upon determination that change of the traveling lane of the own vehicle to a selected other lane included in the at least one other lane is suitable, i.e., lane change is suitable, the output unit 2i outputs, to a notification system 6, an information signal indicative of lane change being suitable as the determination result if the own vehicle is traveling in the manual driving mode.

The notification system 6 includes, for example, a meter display, at least one head-up display, and/or at least one speaker. In response to receiving the information signal from the output unit 2i, the notification system 6 outputs, to the driver of the own vehicle, information that prompts the driver of the own vehicle to perform a lane change operation. Specifically, the notification system 6 can display, on the mater display and/or the at least one head-up display, an icon that prompts the driver to perform a lane change operation. The notification system 6 can output, from the at least one speaker, guidance that encourages the driver to perform a lane change operation. Such a lane change operation is a driving operation of changing the traveling lane of the own vehicle to another lane; the lane change operation includes, for example, a steering operation of causing the own vehicle to straddle one of the lane markers of the traveling lane.

Upon determination that change of the traveling lane of the own vehicle to a selected other lane included in the at least one other lane is suitable, i.e., lane change is suitable, the output unit 2i outputs, to a cruise control system 7, an information signal indicative of lane change being suitable as the determination result if the own vehicle is traveling in the autonomous driving mode.

The cruise control system 7 is configured to perform control tasks related to how the own vehicle travels; the control tasks include, for example, an acceleration control task, a deceleration control task, and a steering control task.

Specifically, in response to receiving the information signal from the output unit 2i, the cruise control system 7 performs an autonomous-driving control task of lane change. The autonomous-driving control task of lane change is to cause the own vehicle to straddle one of the lane markers of the traveling lane without driver's steering operations to accordingly change the traveling lane of the own vehicle to another lane.

More specifically, the cruise control system 7 can determine whether circumstances that enable lane change safely and securely are established in accordance with the traffic situation of the destination road for the own vehicle, the external situation around the own vehicle, and the speed of the own vehicle.

Then, the cruise control system 7 performs the autonomous-driving control task of lane change upon determining that circumstances that enable lane change safely and securely are established. The cruise control system 7 can cooperate to the notification system 6, so that the notification system 6 outputs, to the driver of the own vehicle, information indicative of execution of the autonomous-driving control task of lane change.

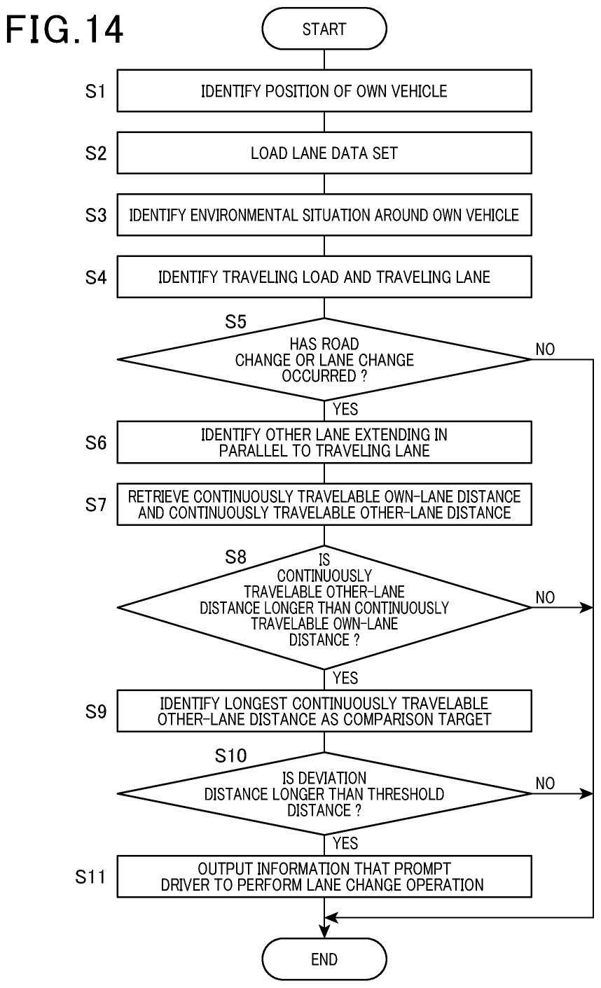

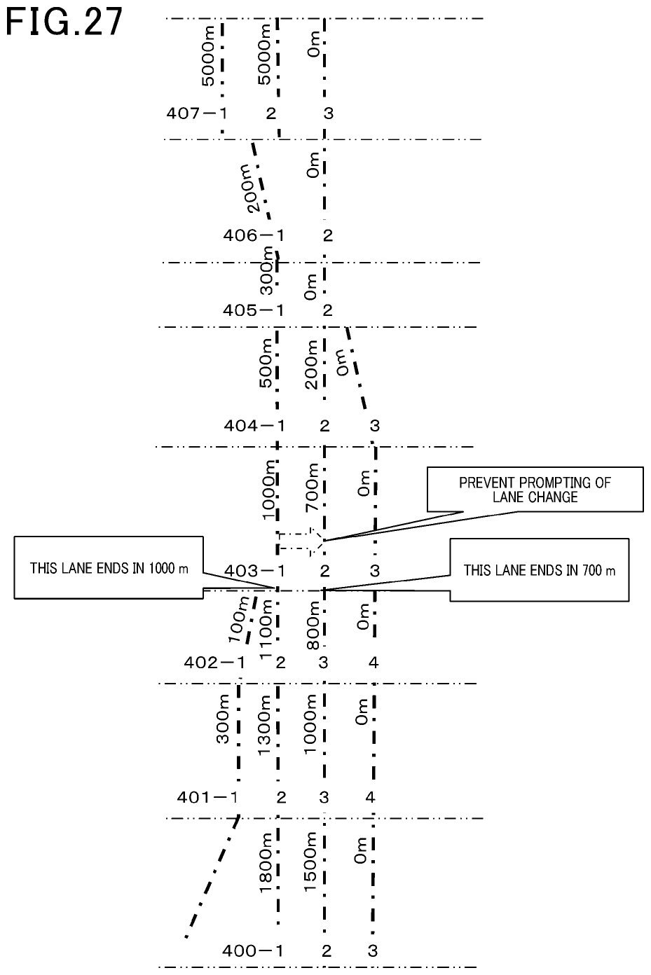

The following describes how the lane keeping apparatus 1 operates with reference to FIGS. 1 to 30.

First, the following describes how the lane keeping apparatus 1 operates assuming that the own vehicle operates in the manual driving mode. The controller 2 of the lane keeping apparatus 1 is configured to, if the execution of the lane keeping function is selected, perform a lane keeping control routine of performing control of the speed of the own vehicle and/or control of steering of the own vehicle to accordingly keep the own vehicle in the center of the traveling lane.

Additionally, the controller 2 of the lane keeping apparatus 1 is configured to perform, in parallel to the lane keeping control routine, a lane-change determination routine of determining whether lane change is suitable every predetermined period, such as every several millisecond period.

The following describes the lane-change determination routine.

In response to the occurrence of an event that represents the start of the lane-change determination routine as a current lane-change determination routine, the controller 2 starts to perform the current lane-change determination routine, and identifies the current position of the own vehicle based on the measurement signals inputted from the vehicle position sensor unit 4 in step S1. When determining that the current position of the own vehicle, the controller 2 loads, from the lane data storage unit 3, lane data sets located at and around the current position of the own vehicle in step S2; the operation in step S2 serves as a first retrieving procedure.

If the lane data storage unit 3 is configured to be in cooperation with the one or more external servers set forth above, the controller 2 can load, from the lane data storage unit 3, lane data sets downloaded from the one or more external serves through one or more communication networks and temporarily stored in the lane data storage unit 3.

Next, the controller 2 identifies the environmental situation around the own vehicle in accordance with the measurement signals inputted from the external surrounding situation sensor unit 5 to accordingly identify the environmental situation around the own vehicle in step S3.

Following the operation in step S3, the controller 2 identifies the road number and lane number corresponding to the current position of the own vehicle in step S4. Then, in step S4, the controller 2 identifies the traveling road and traveling lane on which the own vehicle is traveling in accordance with
(I) The road number and lane number identified in the current lane-change determination routine
(II) The environmental situation around the own vehicle identified in the current lane-change determination routine

The operation in step S4 serves as a first identifying procedure.

Following the operation in step S4, the controller 2 determines whether the road number identified in the current lane-change determination routine has changed from the road number identified in an immediately previous lane-change determination routine, and whether the lane number identified in the current lane-change determination routine has changed from the lane number identified in the immediately previous lane-change determination routine in step S5.

When determining that neither the road number identified in the current lane-change determination routine has changed from the road number identified in the immediately previous lane-change determination routine nor the lane number identified in the current lane-change determination routine has changed from the lane number identified in the immediately previous lane-change determination routine although the position of the own vehicle has changed (NO in step S5), the controller 2 terminates the current lane-change determination routine, and waits for the occurrence of an event that represents the start of the lane-change determination routine as a next lane-change determination routine.

Otherwise, when determining that one of the road number identified in the current lane-change determination routine has changed from the road number identified in the immediately previous lane-change determination routine and the lane number identified in the current lane-change determination routine has changed from the lane number identified in the immediately previous lane-change determination routine in response to change of the position of the own vehicle (YES in step S5), the controller 2 identifies the road segment number of the traveling lane corresponding to the current position of the own vehicle in step S6.

Then, the controller 2 identifies at least one other lane that extends in parallel to the traveling lane of the own vehicle in accordance with the identified road segment number in step S6.

The controller 2 retrieves, from the lane data sets loaded from the lane data storage unit 3, (i) the continuously travelable distance of the traveling lane of the own vehicle as the continuously travelable own-lane distance, and (ii) a continuously travelable distance of the at least one other lane as the continuously travelable other-lane distance in step S7.

Then, the controller 2 performs a comparison between the continuously travelable own-lane distance and the continuously travelable other-lane distance in step S8.

If the own vehicle travels one side lane of a two-lane section in each way, the controller 2 compares the continuously travelable own-lane distance of the one side lane with the continuously travelable other-lane distance of the other-side lane of the two-lane section.

Otherwise, if the own vehicle travels one lane included in a lane section of three or more lanes in each way, the controller 2 compares the continuously travelable own-lane distance of the one lane with the continuously travelable other-lane distance of each of the three or more lanes of the lane section.

When determining, based on the comparison, that the continuously travelable other-lane distance is smaller than or equal to the continuously travelable own-lane distance, the controller 2 determines that no continuously travelable other-lane distances longer than the continuously travelable own-lane distance are present (NO in step S8), terminating the current lane-change determination routine. Then, the controller 2 waits for the occurrence of an event that represents the start of the lane-change determination routine as a next lane-change determination routine.

That is, when determining that the continuously travelable own-lane distance is longer than or equal to the continuously travelable other-lane distance of the at least one other lane, the controller 2 determines a current traffic situation where continuously keeping the own vehicle in the traveling lane enables the own vehicle to travel, without lane change, as long as possible, and therefore the controller 2 prevents the notification system 6 from outputting information that prompts the driver of the own vehicle to perform lane change.

Otherwise, when determining, based on the comparison, that the continuously travelable other-lane distance of the at least one other lane, which is longer than the continuously travelable own-lane distance, is present (YES in step S8), the controller 2 performs an identification operation in step S9. Specifically, if the single continuously travelable other-lane distance is determined to be longer than the continuously travelable own-lane distance, the controller 2 identifies the single continuously travelable other-lane distance as a comparison target distance in step S9. Otherwise, if plural continuously travelable other-lane distances are determined to be longer than the continuously travelable own-lane distance, the controller 2 selects one of the plural continuously travelable other-lane distances, which is the longest, as the comparison target distance in step S9.

Following the identification of the comparison target in step S9, the controller 2 calculates a deviation distance that represents the deviation of the comparison target distance from the continuously travelable own-lane distance in step S10. Then, the controller 2 compares, in step S10, the calculated deviation distance with the predetermined threshold distance to accordingly determine, based on the comparison result, whether lane change from the traveling lane to the other lane corresponding to the comparison target distance is suitable; the operation in step S10 serves as a first determination procedure.

When determining that the calculated deviation distance is longer than the predetermined threshold distance to accordingly determine that lane change from the traveling lane to a selected lane included in the at least one other lane is suitable (YES in step S10), the controller 2 outputs, to the notification system 6, an information signal that causes the notification system 6 to output information that prompts the driver of the own vehicle to perform a lane change operation in step S11; the operation in step S11 serves as an output procedure.

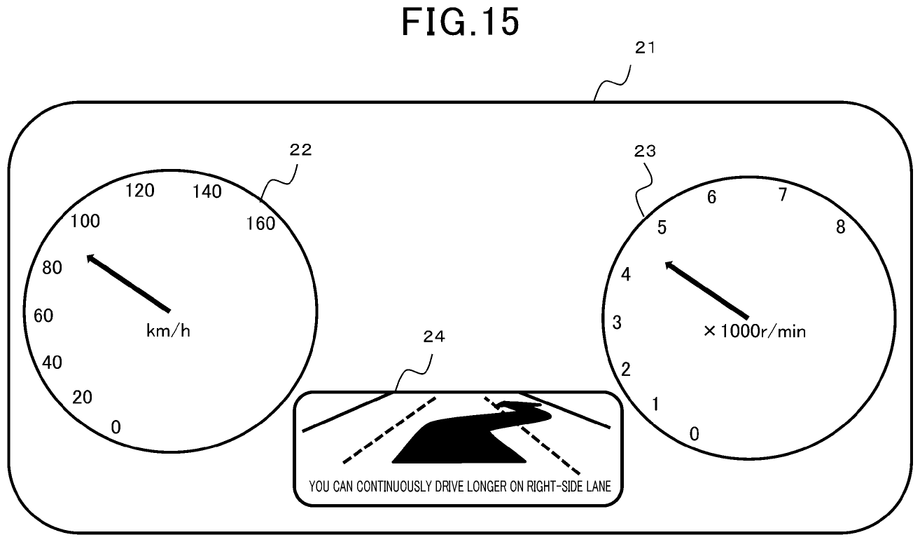

For example, the controller 2 causes the notification system 6 to display, on a meter display 21 illustrated in FIG. 15, an icon 24 between a vehicle speed meter 22 and a tachometer 23 indicative of the speed of the engine; the icon 24 prompts the driver to perform the lane change operation.

That is, when determining that one or more continuously travelable other-lane distances are longer than the continuously travelable own-lane distance, the controller 2 determines a current traffic situation where lane change of the own vehicle from the current traveling lane to another lane enables the own vehicle to travel on the changed lane as long as possible while continuously performing the lane keeping function, and therefore the controller 2 causes the notification system 6 to encourage the driver of the own vehicle to perform the lane change operation.

FIG. 15 illustrates the icon 24 that represents a message “YOU CAN CONTINUOUSLY DRIVE LONGER ON RIGHT-SIDE LANE”, but the icon 24 can represent any message that prompts the driver to perform lane change. The controller 2 can cause the notification system 6 to display the icon 24 only for a predetermined time or can cause the notification system 6 to continuously display the icon 24 until the driver of the own vehicle starts to perform lane change.

The controller 2 can cause the notification system 6 to display the icon 24 colored in blue when determining that the continuously travelable own-lane distance is relatively long, i.e., there are relatively many chances to perform lane change, so that the driver has sufficient time to perform lane change. In contrast, the controller 2 can cause the notification system 6 to display the icon 24 colored in red when determining that the continuously travelable own-lane distance is relatively short, i.e., there are relatively few chances to perform lane change, so that the driver does not have sufficient time to perform lane change. That is, the controller 2 can cause the notification system 6 to inform the driver of how long the driver has chances to perform lane change.

Additionally, the controller 2 can cause the notification system 6 to display a value of each of the continuously travelable own-lane distance, the continuously travelable other-lane distance, and the deviation distance in addition to the message that prompts the driver to perform lane change. This makes it possible to provide, to the driver of the own vehicle, information for making a decision of whether the driver performs a lane change operation.

Otherwise, when determining that the calculated deviation distance is smaller than or equal to the predetermined threshold distance to accordingly determine that lane change from the traveling lane to the at least one other lane is unsuitable (NO in step S10), the controller 2 waits for the occurrence of an event that represents the start of the lane-change determination routine as a next lane-change determination routine.

That is, although determining that the one or more continuously travelable other-lane distances are longer than the continuously travelable own-lane distance, the controller 2 determines whether there is much difference between
(I) A first continuously travelable distance for a first case where lane change of the own vehicle is performed from the traveling lane to another lane
(II) A second continuously travelable distance for a second case where the own vehicle continuously travels on the traveling lane without lane change

Then, upon determining that there is not much difference between the first continuously travelable distance and the second continuously travelable distance, the controller 2 prevents the notification system 6 from outputting information that prompts the driver of the own vehicle to perform lane change.

The following describes how the lane keeping apparatus 1 operates under specific first to third cases:

The first case is that the traveling road of the own vehicle is configured such that the number of lanes decrease in the forward direction of the own vehicle.

The second case is that the destination of the traveling lane of the own vehicle is changed in the forward direction of the own vehicle.

The third case is that the traveling road of the own vehicle is configured such that the number of lanes increases in the forward direction of the own vehicle.

### (I) First Case

First, the following describes how the lane keeping apparatus 1 operates under the first case where the traveling road of the own vehicle is configured such that the number of lanes decrease in the forward direction of the own vehicle.

In the geometry of the traveling road illustrated in FIG. 5 in which the number of lanes decreases in the forward direction of the own vehicle, let us assume that the own vehicle, which is traveling on an acceleration/slip lane 101-1 in the road segment, i.e., the acceleration segment before merging, with the segment number (101), performs lane change from the acceleration/slip lane 101-1 to a lane 101-2.

Thereafter, in response to the own vehicle having entered the road segment, i.e., the normal-lane segment, with the segment number (103), the lane keeping apparatus 1 compares the continuously travelable distance (600 m) of the traveling lane 103-1 with the continuously travelable distance (5600 m) of the other lane 103-2 that extends parallel to the traveling lane 103-1 of the own vehicle.

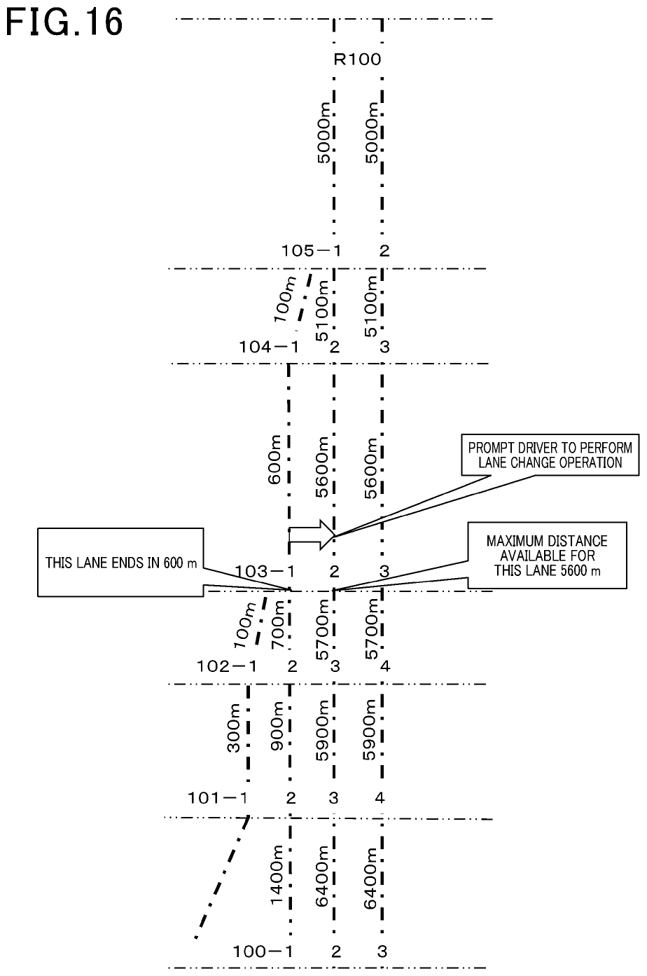

As illustrated in FIG. 16, the continuously travelable distance (600 m) of the traveling lane 103-1 relative to the start point of the road segment with the segment number (103) means that the own vehicle will continuously travel on the traveling lane 103-1 only 600 m. In contrast, the continuously travelable distance (5600 m) of the other lane 103-2, which extends parallel to the traveling lane 103-1, means that the own vehicle will continuously travel on the traveling lane 103-2 by a maximum of 5600 m.

Because the continuously travelable distance (5600 m) of the other lane 103-2 is longer than the continuously travelable distance (600 m) of the traveling lane 103-1, the lane keeping apparatus 1 determines that lane change from the traveling lane 103-1 to the other lane 103-2 is suitable, thus prompting the driver of the own vehicle to perform a lane change operation from the traveling lane 103-1 to the other lane 103-2.

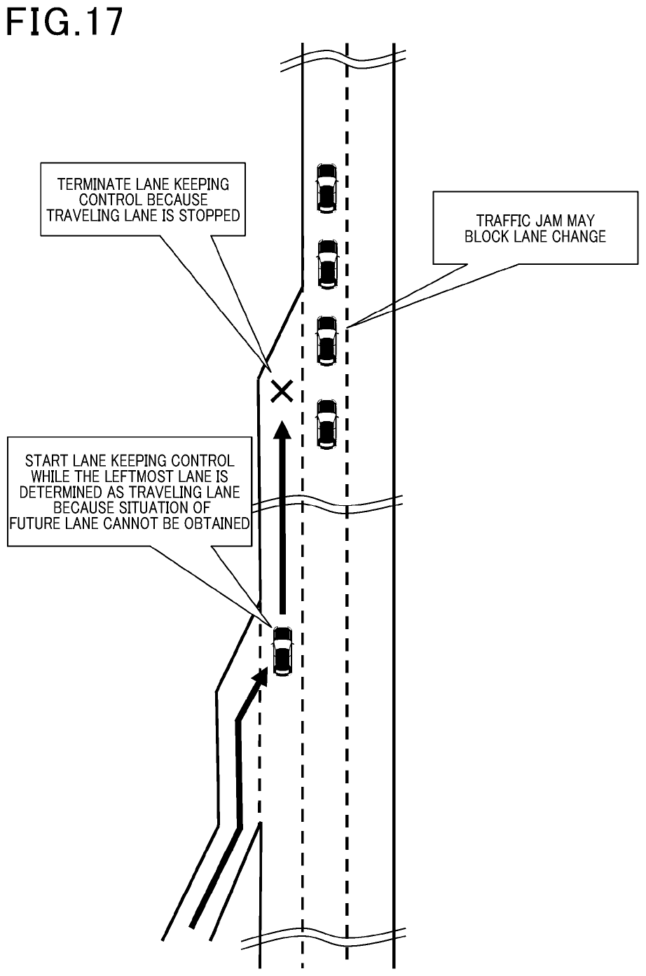

As illustrated in FIG. 17, let us assume that decrease in the number of lanes in the forward direction of the own vehicle results in the traveling lane of the own vehicle ending.

In this assumption, continuous traveling of the own vehicle on the traveling lane may cause the lane keeping control routine not to be continuable, resulting in the lane keeping control routine being terminated. Additionally, in this assumption, the traveling road includes one segment, which will be referred to as a last segment, defined such that the number of lanes in the next segment decreases, i.e., the traveling road disappears. At that time, at least one other lane in the last segment may be congested. The traffic jam of the at least one other lane in the last segment may block lane change from the traveling lane to the at least one other lane.

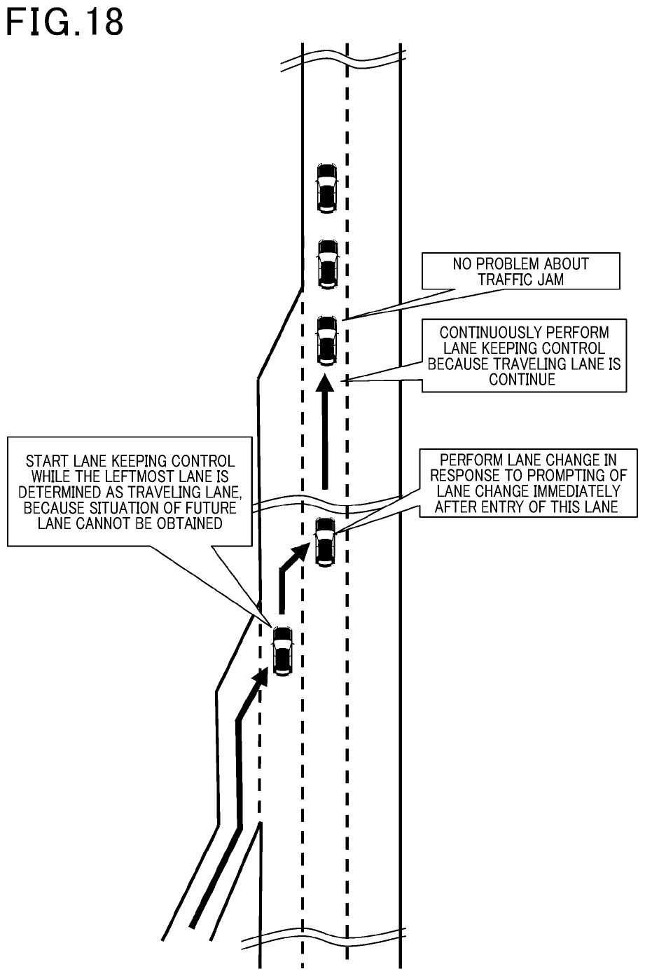

From this viewpoint, the above lane-change determination routine of the exemplary embodiment makes it possible to prompt, as illustrated in FIG. 18, the own vehicle, which has just entered the normal-lane segment with the segment number (103), to perform lane change from the traveling lane to the at least one other lane. This enables the lane keeping control routine to be continuously carried out on the at least one other lane as long as possible.

The controller 2 can cause the notification system 6 to output, to the driver of the own vehicle, first information that prompts the driver of the own vehicle to perform lane change, and second information indicative of the reason for prompting the driver of the own vehicle to perform lane change. For example, when outputting the first information, the controller 2 can cause the notification system 6 to display a message “CHANGE TO RIGHT LANE BECAUSE NUMBER OF LANES WILL DECREASE” or output a sound guidance representing a message “CHANGE TO RIGHT LANE BECAUSE NUMBER OF LANES WILL DECREASE”.

### (II) Second Case

Next, the following describes how the lane keeping apparatus 1 operates under the second case where the destination of the traveling lane of the own vehicle is changed in the forward direction of the own vehicle.

In the geometry of the traveling road illustrated in FIG. 8 in which the destination of the traveling lane of the own vehicle is changed in the forward direction of the own vehicle, let us assume that the own vehicle, which is traveling on an acceleration/slip lane 201-1 in the road segment, i.e., the acceleration segment before merging, with the segment number (201), performs lane change from the acceleration/slip lane 201-1 to a lane 201-2.

Thereafter, in response to the own vehicle having entered the road segment, i.e., the normal-lane segment, with the segment number (203), the lane keeping apparatus 1 compares the continuously travelable distance (700 m) of the traveling lane 203-1 with the continuously travelable distance (5700 m) of the other lane 203-2 that extends parallel to the traveling lane 203-1 of the own vehicle.

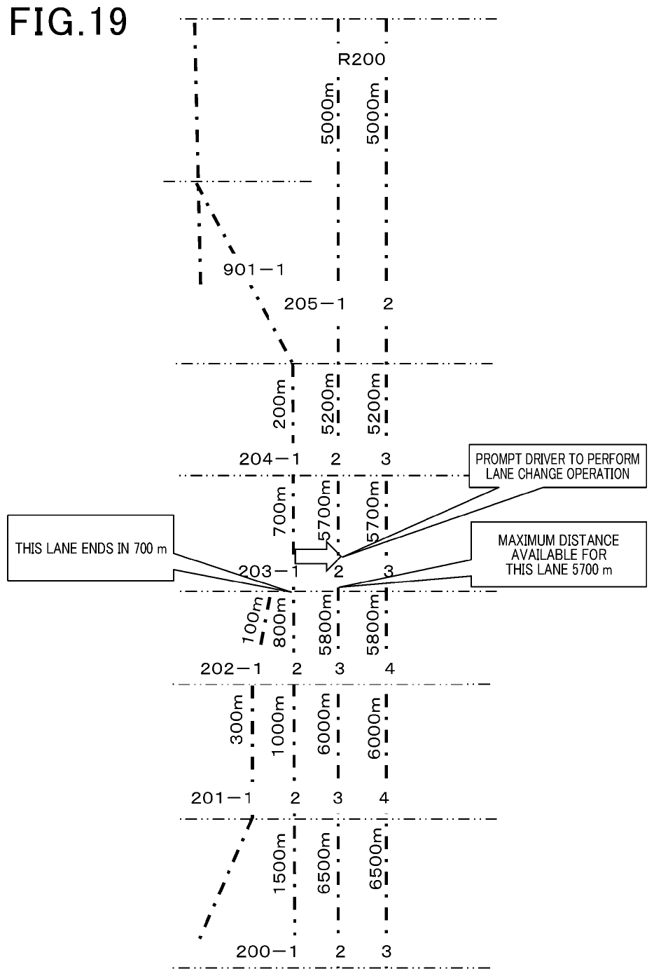

As illustrated in FIG. 19, the continuously travelable distance (700 m) of the traveling lane 203-1 relative to the start point of the road segment with the segment number (203) means that the own vehicle will continuously travel on the traveling lane 203-1 only 700 m. In contrast, the continuously travelable distance (5700 m) of the other lane 203-2, which extends parallel to the traveling lane 203-1, means that the own vehicle will continuously travel on the traveling lane 203-2 by maximum of 5700 m.

Because the continuously travelable distance (5700 m) of the other lane 203-2 is longer than the continuously travelable distance (700 m) of the traveling lane 203-1, the lane keeping apparatus 1 determines that lane change from the traveling lane 203-1 to the other lane 203-2 is suitable, thus prompting the driver of the own vehicle to perform a lane change operation from the traveling lane 203-1 to the other lane 203-2.

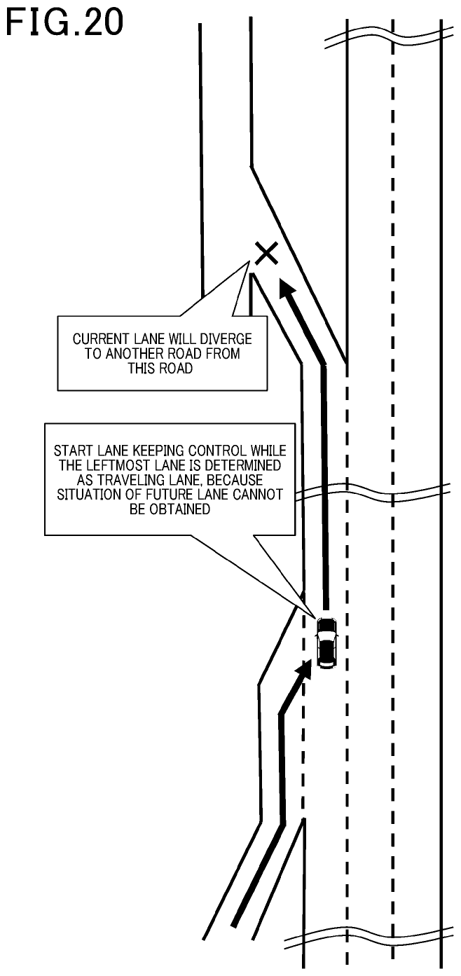

As illustrated in FIG. 20, let us assume that the traveling lane of the own vehicle is joined to an exit-only lane of an expressway or a transfer lane of another road.

In this assumption, continuous traveling of the own vehicle on the traveling lane may cause the own vehicle to enter another road due to the change of the destination of the traveling lane. For avoiding the own vehicle from entering another road, the driver of the own vehicle may need to always recognize road traffic signs and pavement markings to accordingly understand the destination of the traveling lane, so that the driver may have to pay attention to road traffic signs and pavement markings while driving the own vehicle, resulting in the driver's burden increasing.

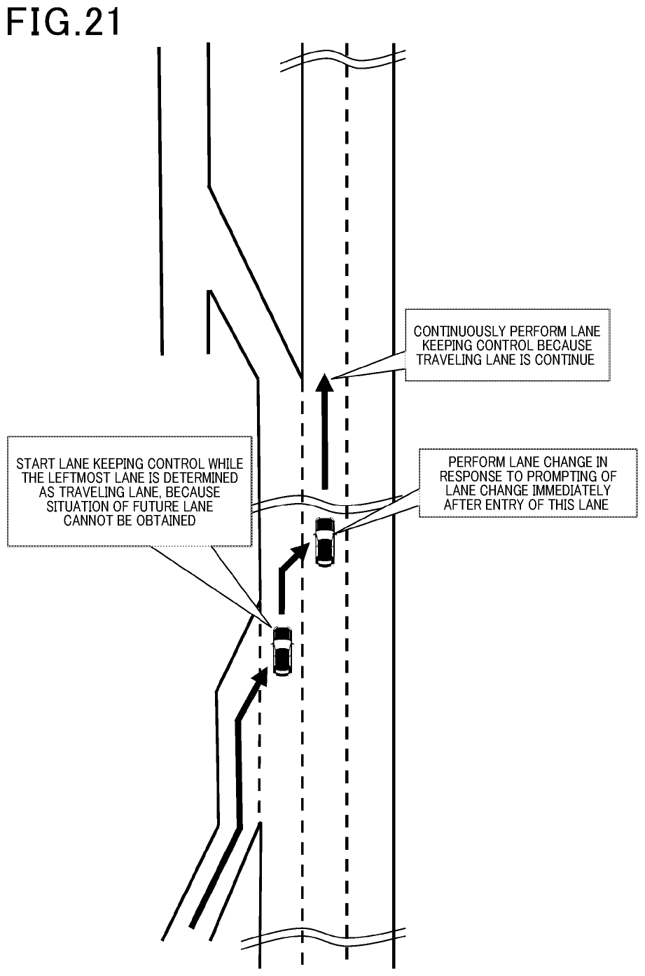

From this viewpoint, the above lane-change determination routine of the exemplary embodiment makes it possible to prompt, as illustrated in FIG. 21, the own vehicle, which has just entered the normal-lane segment with the segment number (203), to perform lane change from the traveling lane to the at least one other lane. This enables the lane keeping control routine to be continuously carried out on the at least one other lane as long as possible. This also can reduce the driver's efforts required for the driver to pay attention to road traffic signs and pavement markings while driving the own vehicle, making it possible to reduce the driver's burden.

Like the first case, when outputting the first information, the controller 2 can cause the notification system 6 to display a message “CHANGE TO RIGHT LANE BECAUSE DESTINATION OF TRAVELING LANE WILL BE CHANGED” or output a sound guidance representing a message “CHANGE TO RIGHT LANE BECAUSE DESTINATION OF TRAVELING LANE WILL BE CHANGED”.

### (III) Third Case

Next, the following describes how the lane keeping apparatus 1 operates under the third case where the traveling road of the own vehicle is configured such that the number of lanes increases in the forward direction of the own vehicle.

In the geometry of the traveling road illustrated in FIG. 11 in which the number of lanes increases in the forward direction of the own vehicle, let us assume that the own vehicle, which is traveling on an acceleration/slip lane 301-1 in the road segment, i.e., the acceleration segment before merging, with the segment number (301), performs lane change from the acceleration/slip lane 301-1 to a lane 301-2.

Thereafter, in response to the own vehicle having entered the road segment, i.e., the normal-lane segment, with the segment number (303), the lane keeping apparatus 1 compares the continuously travelable distance (700 m) of the traveling lane 303-1 with the continuously travelable distance (5700 m) of the other lane 303-2 that extends parallel to the traveling lane 303-1 of the own vehicle.

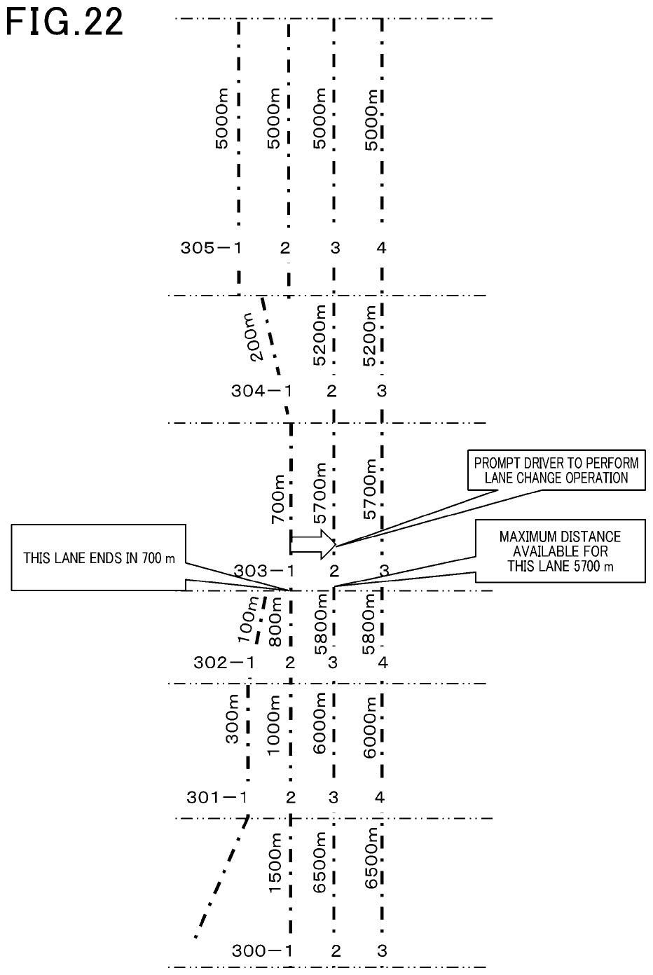

As illustrated in FIG. 22, the continuously travelable distance (700 m) of the traveling lane 303-1 relative to the start point of the road segment with the segment number (303) means that the own vehicle will continuously travel on the traveling lane 303-1 only 700 m. In contrast, the continuously travelable distance (5700 m) of the other lane 303-2, which extends parallel to the traveling lane 303-1, means that the own vehicle will continuously travel on the traveling lane 303-2 by a maximum of 5700 m.

Because the continuously travelable distance (5700 m) of the other lane 303-2 is longer than the continuously travelable distance (700 m) of the traveling lane 303-1, the lane keeping apparatus 1 determines that lane change from the traveling lane 303-1 to the other lane 303-2 is suitable, thus prompting the driver of the own vehicle to perform a lane change operation from the traveling lane 303-1 to the other lane 303-2.

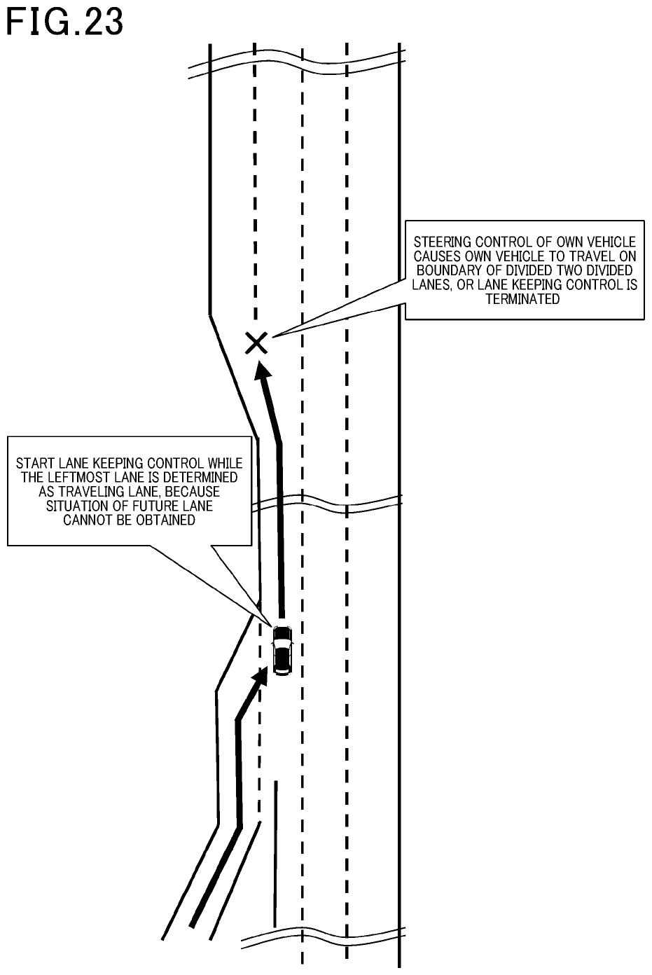

As illustrated in FIG. 23, let us assume that an increase in the number of lanes in the forward direction of the own vehicle causes the width of the traveling lane of the own vehicle to gradually increase, so that a new lane marker appears in the center of the widened traveling lane, resulting in the traveling lane being divided into two lanes.

In this assumption, continuous traveling of the own vehicle on the traveling lane may result in the controller 2 determining that
(i) The steering control of the own vehicle based on the lane keeping control routine causes the own vehicle to travel on the boundary of the divided two lanes
(ii) The own vehicle is out of control due to the widening of the traveling lane, resulting in the lane keeping control routine being not continuable and thereafter being terminated

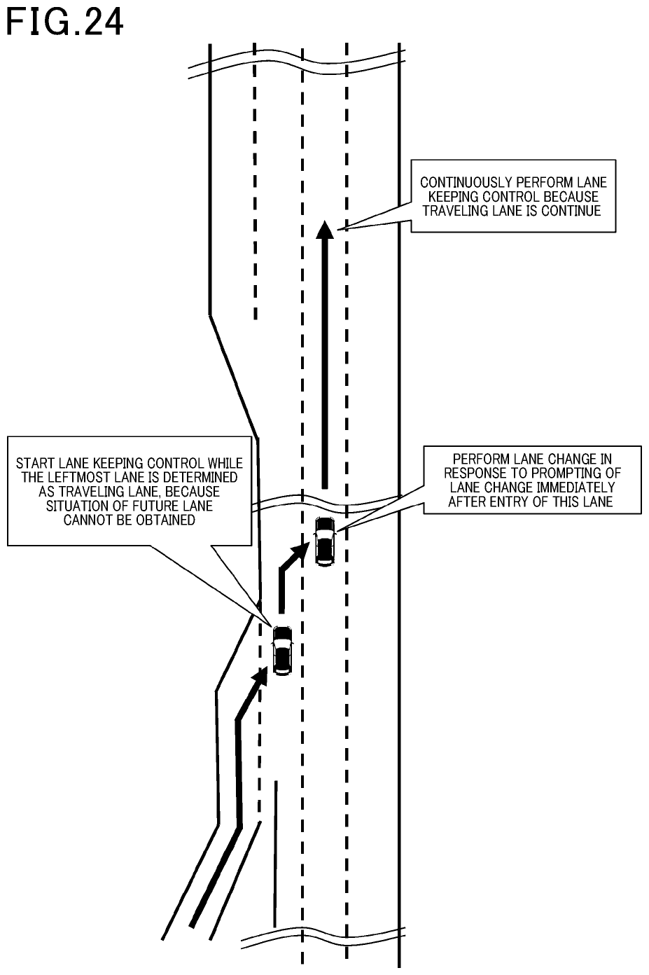

From this viewpoint, the above lane-change determination routine of the exemplary embodiment makes it possible to prompt, as illustrated in FIG. 24, the own vehicle, which has just entered the normal-lane segment with the segment number (303), to perform lane change from the traveling lane to a selected lane included in the at least one other lane. This enables the lane keeping control routine to be continuously carried out on a selected lane included in the at least one other lane as long as possible.

Like the first case, when outputting the first information, the controller 2 can cause the notification system 6 to display a message “CHANGE TO RIGHT LANE BECAUSE NUMBER OF LANES WILL INCREASE” or output a sound guidance representing a message “CHANGE TO RIGHT LANE BECAUSE NUMBER OF LANES WILL INCREASE”.

The above has described how the lane keeping apparatus 1 operates assuming that the own vehicle operates in the manual driving mode.

In contrast, assuming that the own vehicle operates in the autonomous driving mode, the controller 2 is configured to output, to the cruise control system 7, the information signal indicative of lane change being suitable in place of causing the notification system 6 to prompt the driver of the own vehicle to lane change.

In response to receiving the information signal, the cruise control system 7 smoothly performs the autonomous-driving control task of, for example, calculating a scheduled traveling route or path for the own vehicle; the scheduled traveling route or path enables the own vehicle to continuously travel on the same traveling lane.

The above has described assuming that the own vehicle can travel on any lane in the traveling road, but continuous traveling of the own vehicle on a specific lane in a traveling road may result in violation of the traffic regulations in a particular country or a particular region depending on the traffic regulations.

The following describes cases where the own vehicle cannot continuously travel on all lanes of a traveling road due to the traffic regulations.

In Japan, the far-right lane in multi-lane expressway serves as a passing lane, and if any vehicle were traveling in the passing lane of the multi-lane expressway under the situation that all the remaining lanes in the multi-lane expressway, the vehicle would violate the traffic regulations in Japan.

In Germany, for a multi-lane road, the traffic regulations define that any vehicle should travel on the far-right lane, and that the remaining lanes serve as passing lanes. For this reason, in Germany, if any vehicle is traveling in the center lane on a three-lane road, the vehicle may violate the traffic regulations in Germany. For reference, each of the Geneva Convention on Road Traffic and the succeeding Vienna Convention on Road Traffic describes as general rules, that any vehicle should select one of lanes in accordance with the Germany's traffic regulations.

In United States, traffic regulations vary from state to state.

For example, in California, any vehicle can continuously travel on the left lane as a passing lane. In, for example, each of Maine, Massachusetts, Missouri, Montana, New Jersey, and Washington, for a multi-lane road, the traffic regulations define that any vehicle should travel on the far-right lane, as in Germany.

In, for example, Texas, if you see a sign that reads, “Left Lane For Passing Only” while driving on a multi-lane road, the left lane should be used only as a passing lane, and therefore, like Japan, if you were continuously driving on the left lane, i.e., the passing lane, of a multi-lane road, you would violate the traffic regulations in Texas. However, if you do not see a sign that reads, “Left Lane For Passing Only” while driving on a multi-lane road, you can continuously drive on the left lane of a multi-lane road.

In order to operate the lane keeping apparatus 1 of the exemplary embodiment in any region of the actual world, it is necessary to assign, in the lane data set for each road illustrated in FIGS. 2 to 4, a predetermined numeric value in any unit as the continuously travelable distance for each segment of each lane of the corresponding road.

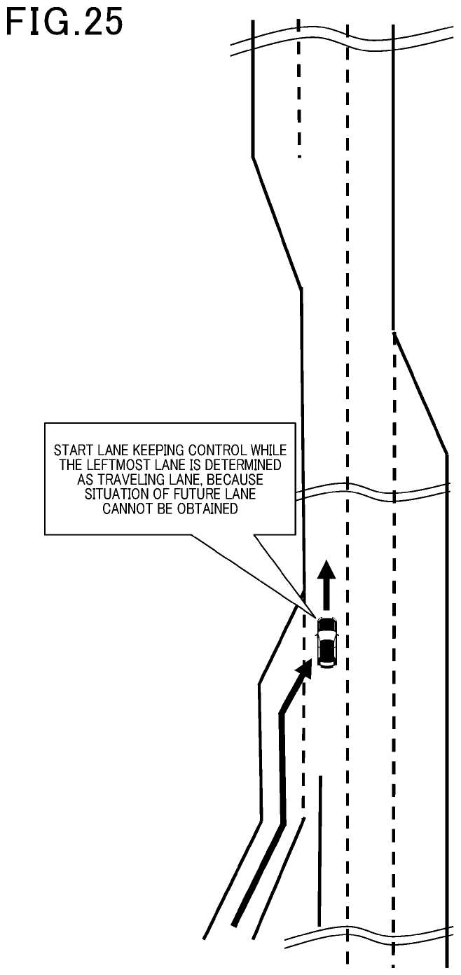

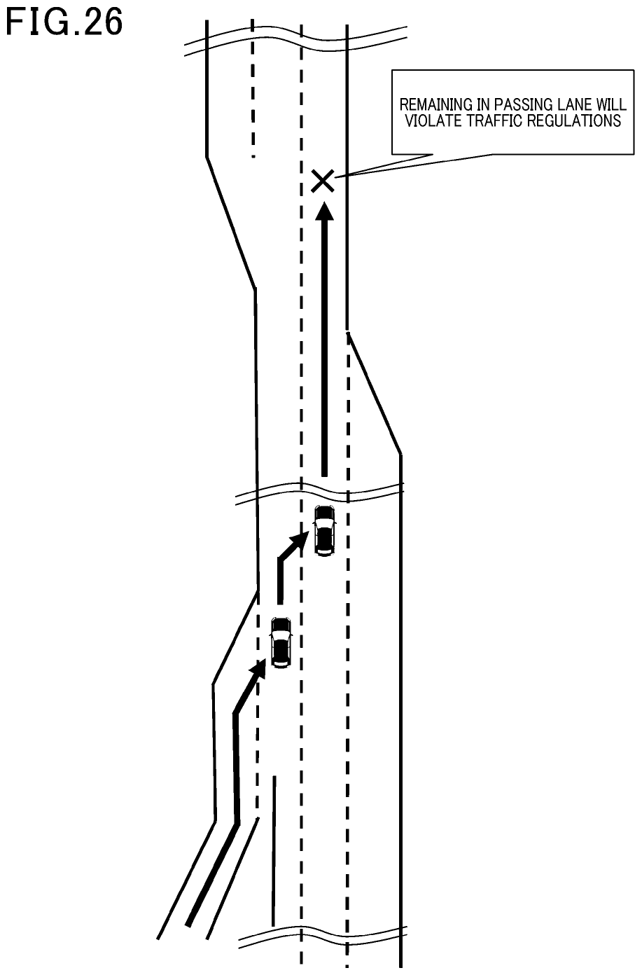

For example, let us consider the road configuration illustrated in FIGS. 25 and 26 in Japan. For the road configuration illustrated in FIGS. 25 and 26, always assigning 0 m as the continuously travelable distance for the right-edge lane of each road segment prevents the lane keeping apparatus 1 from prompting the driver of the own vehicle to perform lane change toward the right-edge lane, i.e., the passing lane.

Specifically, in response to the own vehicle having entered the road segment, i.e., the normal-lane segment, with the segment number (403), the lane keeping apparatus 1 compares the continuously travelable distance (1000 m) of the traveling lane 403-1 with the continuously travelable distance (700 m) of the other lane 403-2 that extends parallel to the traveling lane 403-1 of the own vehicle.

Unlike the situations illustrated in FIGS. 16, 19, and 22, because the continuously travelable distance (1000 m) of the traveling lane 403-1 is longer than the continuously travelable distance (700 m) of the other lane 403-2, the lane keeping apparatus 1 determines that lane change from the traveling lane 403-1 to the other lane 403-2 is unsuitable, thus preventing the output of information that prompts the driver of the own vehicle to perform a lane change operation.

As another example, for each road segment in Germany, calculating the continuously travelable distance for the right-edge lane of the corresponding road segment based on the distance of the corresponding road segment and always assigning 0 m as the continuously travelable distance for each of the other lanes of the corresponding road prevent the lane keeping apparatus 1 from prompting the driver of the own vehicle to perform an illegal lane change operation.

That is, assuming that the lane keeping apparatus 1 is used to operate in countries in which 0 m is always assigned as the continuously travelable distance for one or more lanes included in each road segment, it may be difficult to achieve advantageous effects expected by the configuration of the lane keeping apparatus 1. It is however possible to operate the lane keeping apparatus 1 in Germany, because vehicles each equipped with the lane keeping apparatus 1 can travel between Germany and another country, so that traffic regulations may be changed while the vehicles travel on any road between Germany and another country. Similarly, it is possible to operate the lane keeping apparatus 1 in the United States, because vehicles each equipped with the lane keeping apparatus 1 can travel between states, so that traffic regulations may be changed while the vehicles travel on any road between states.

The exemplary embodiment can be used not only for selected roads where no intersections are provided, such as expressways but also for public roads where intersections are provided. At that time, because each public road includes one or more sections, such as intersections, where no lanes are provided, a specific measure is required in generation of lane data sets for each public road.

Specifically, for each intersection passing through any public road, intersection connection information is generated. The intersection connection information for each intersection is network data that enable whether each entry lane that enters the corresponding intersection is connected to an exit lane that exits from the corresponding intersection to be specified.

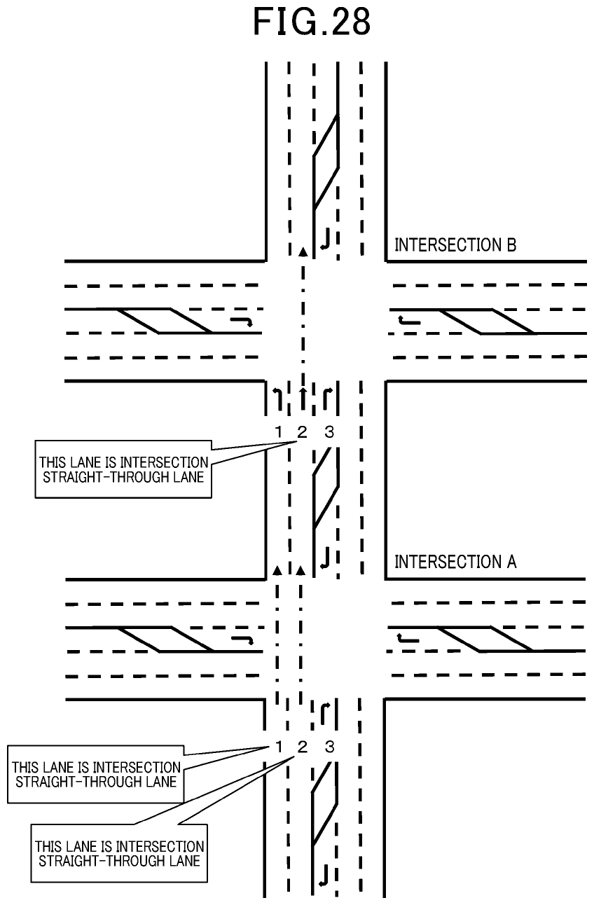

The lane keeping apparatus 1 is configured to, when the own vehicle enters an intersection, determines, based on the network data, whether the traveling lane of the own vehicle can go into an opposite-side lane across the intersection while maintaining execution of the lane keeping control routine. A lane that enables the own vehicle to go into an opposite-side lane across an intersection while execution of the lane keeping control routine is maintained will be referred to as an intersection straight-through lane. At that time, for example, entry lanes with the respective lane numbers (1) and (2) illustrated in FIG. 28, which enter an intersection A, are intersection straight-through lanes, and an entry lane with the lane number (2), which enters an intersection B, is also an intersection straight-through lane.

The lane keeping apparatus 1 is configured to check the connection relationship of the intersection based on a lane use control sign located upstream of the intersection while determining whether continuously performing the lane keeping control routine to accordingly determine whether the traveling lane of the own vehicle is an intersection straight-through lane.

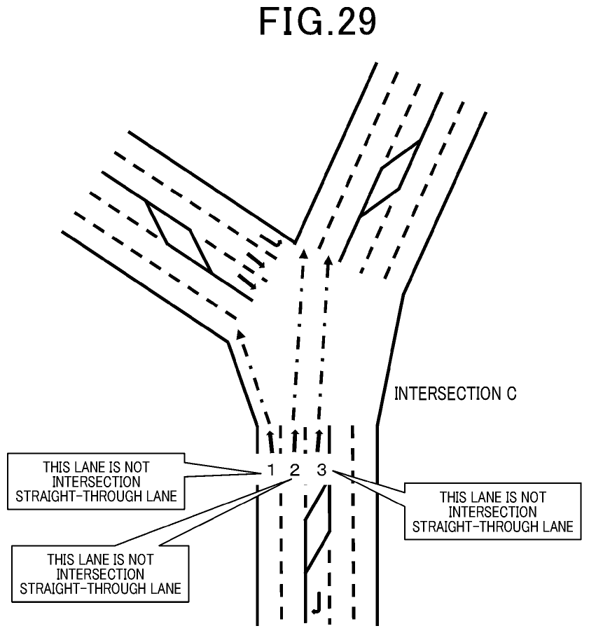

For example, as illustrated in FIG. 29, if an angle formed between an entry lane that enters an intersection C and each exit lane that exits from the intersection C is relatively large so that it is difficult for the lane keeping apparatus 1 to identify an exit lane that the traveling lane of the own vehicle follows through the intersection C, the lane keeping apparatus 1 cannot determine whether the traveling lane of the own vehicle is an intersection straight-through lane. In FIG. 29, all the entry lane with the lane number (1), the entry lane with the lane number (2), and the entry lane with the lane number (3) are determined not to be intersection straight-through lanes.

Note that any entry vehicle, which travels on an intersection straight-through lane, cannot necessarily travel continuously through an intersection due to (i) traffic-flow control by one or more traffic lights at the intersection and (ii) traffic negotiations among entry vehicles based on stop signs at the intersection. The lane keeping apparatus 1 can be configured to assist stop control and/or safety confirmation control for the own vehicle at a target intersection in cooperation with (i) a system for acquiring information about how each traffic light at the target intersection is cyclically turned on and (ii) a system for acquiring information about other vehicles traveling on lanes that crosses the traveling lane of the own vehicle.

Next, the following provides a supplementary explanation of the lane data sets.

The lane data set for each road is, as described above, comprised of (i) the road number, (ii) the road segment number for each segment, (iii) the lane number of at least one lane, (iv) the type of the at least one lane, (v) the destination of the at least one lane, and (vi) the continuously travelable distance for the at least one lane included in each road segment.

The road number, the road segment number for each segment, and the lane number of the at least one lane, which are included in the lane data set for each road, i.e., cartographic data of the at least one lane included in each road, serve as components for correlating the configuration of the corresponding road, the type of the at least one lane, the destination of the at least one lane, and the continuously travelable distance for the at least one lane with one another. That is, the lane data set for each road includes, as attributes directly related to the lane-change determination routine, (i) the road number, (ii) the type of the at least one lane, (iii) the destination of the at least one lane, and (iv) the continuously travelable distance. Any measure can be used to add data items of these attributes to the lane data set for each road. That is, the lane keeping apparatus 1 is configured to acquire at least
(I) A traveling road corresponding to the current position of the own vehicle
(II) A traveling lane corresponding to the current position of the own vehicle
(III) A road number corresponding to the traveling road
(IV) A type of at least one lane included in the traveling road
(V) A destination of the at least one lane
(VI) A continuously travelable distance of the at least one lane

That is, it is possible to reduce the volume of the lane data set for each road.

The lane data set, i.e., the cartographic lane data set, for each road can be divided into plural lane-data subsets corresponding to respective data regions that are obtained by dividing, by a predetermined section, the corresponding road. In this case, only to the termination point of each lane of the end segment included in each lane-data subset, the continuously travelable distance can be assigned, making it possible to reduce the volume of the lane data set for each road. That is, the continuously travelable distance for the termination point of each lane of the end segment included in each lane-data subset cannot be calculated based on the corresponding lane-data subset. For this reason, the continuously travelable distance is assigned only to the termination point of the corresponding lane included in the corresponding lane-data subset, and a continuously travelable distance for each lane of each remaining segment included in the corresponding lane-data subset can be calculated based on the corresponding lane-data subset.

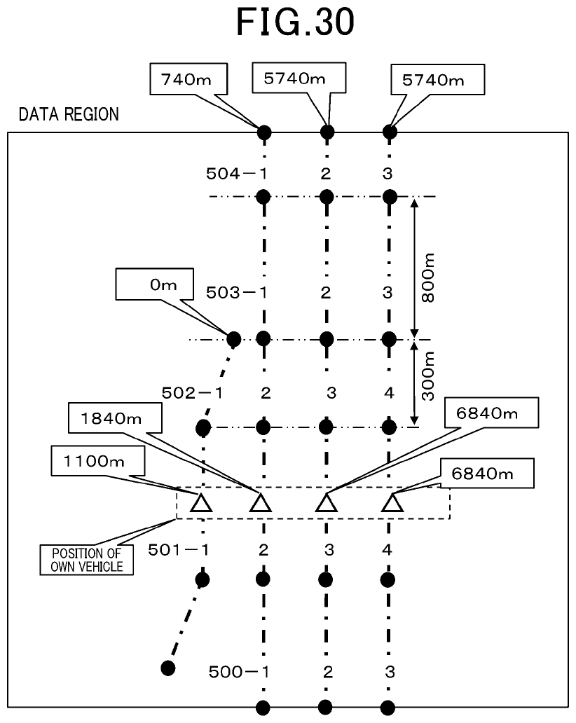

For example, let us assume that, for a selected lane-data subset included in a selected data region, the continuously travelable distances of 740 m, 5740 m, and 5740 m are assigned to the respective termination points of the respective lanes (lane numbers 1, 2, 3) of the end segment with the segment number (504) included in the selected lane-data subset (see FIG. 30).

In this assumption, if the current position of the own vehicle is within the road segment 501, calculating the sum of the continuously travelable distance (740 m) of the end point of the lane segment (540-1) and the segment distance (0 m) of the segment (503), and the segment distance (300 m) of the segment (502) enables the continuously travelable distance (1100 m) of the lane segment (501-1) to be calculated.

Similarly, calculating the sum of the continuously travelable distance (740 m) of the end point of the lane segment (540-1), the segment distance (800 m) of the segment (503), and the segment distance (300 m) of the segment (502) enables the continuously travelable distance (1840 m) of the lane segment (501-2) to be calculated.

Calculating the sum of the continuously travelable distance (5740 m) of the end point of the lane segment (540-2), the segment distance (800 m) of the segment (503), and the segment distance (300 m) of the segment (502) enables the continuously travelable distance (6840 m) of the lane segment (501-3) to be calculated.

Similarly, calculating the sum of the continuously travelable distance (5740 m) of the end point of the lane segment (540-2), the segment distance (800 m) of the segment (503), and the segment distance (300 m) of the segment (502) enables the continuously travelable distance (6840 m) of the lane segment (501-4) to be calculated.

The exemplary embodiment set forth above achieves the following advantageous benefits.

The lane keeping apparatus 1 of the exemplary embodiment is configured to (i) compare a continuously travelable distance of a traveling lane of the own vehicle with a continuously travelable distance of at least one other lane to accordingly determine whether lane change from the traveling lane to the at least one other lane is suitable, and (ii) output a result of the determination of whether lane change from the traveling lane to the at least one other lane is suitable.

Specifically, upon determining that lane change from the traveling lane to the at least one other lane is suitable, the lane keeping apparatus 1 outputs the result of the determination that lane change from the traveling lane to the at least one other lane is suitable. This therefore enables suitable determination of a lane in which the own vehicle will travel, making it possible to signify information that prompts the driver of the own vehicle to perform a lane change operation from the traveling lane to the at least one other lane, and/or instruct the cruise control system 7 to perform an autonomous-driving control task of such lane change. The lane change of the own vehicle from the traveling lane to a selected other lane included in the at least one other lane enables the selected other lane to be maintained as a traveling lane for the own vehicle, making it possible to suitably select any of lanes in a traveling road as a traveling lane in accordance with the configuration of the traveling road.

The lane keeping apparatus 1 of the exemplary embodiment is configured to retrieve, from the lane data storage unit 3, the continuously travelable distances, each of which is defined to correlate with a corresponding road number and corresponding one or more lane numbers. This enables, from the lane data storage unit 3, a target road number and one or more lane numbers correlating with the target road number to be retrieved simultaneously together with the continuously travelable distances, each of which correlates with the target road number and the one or more lane numbers.

The lane keeping apparatus 1 of the exemplary embodiment is configured to compare a continuously travelable distance of a traveling lane included in a traveling road of the own vehicle with a continuously travelable distance of at least one other lane included in the traveling road in response to change of the configuration of the traveling road and/or the traveling lane. This configuration of comparing the continuously travelable distance of the traveling lane included in the traveling road of the own vehicle with the continuously travelable distance of the at least one other lane included in the traveling road immediately after change of the configuration of the traveling road and/or the traveling lane makes it possible to determine whether lane change from the traveling lane to the at least one other lane is suitable immediately after change of the configuration of the traveling road and/or the traveling lane. This therefore makes it possible to, upon determination that lane change is suitable, signify information that prompts the driver of the own vehicle to perform a lane change operation from the traveling lane to the at least one other lane, and/or instruct the cruise control system 7 to perform an autonomous-driving control task of such lane change immediately after change of the configuration of the traveling road and/or the traveling lane.

The lane keeping apparatus 1 of the exemplary embodiment is configured to determine that lane change from the traveling lane to the at least one other lane is suitable in response to determination that
(I) The continuously travelable distance of the at least one other lane is longer than the continuously travelable distance of the traveling lane of the own vehicle
(II) The deviation distance representing the deviation of the continuously travelable other-lane distance from the continuously travelable own-lane distance is longer than the threshold distance

This configuration determines whether lane change from the traveling lane to the at least one other lane makes longer execution of the lane keeping control routine of the own vehicle on a selected other lane included in the at least one other lane. In response to determining that lane change from the traveling lane to the at least one other lane makes longer execution of the lane keeping control routine of the own vehicle on a selected other lane included in the at least one other lane, this configuration signifies information that prompts the driver of the own vehicle to perform a lane change operation from the traveling lane to the at least one other lane, and/or instructs the cruise control system 7 to perform the autonomous-driving control task of such lane change as soon as possible.

The lane keeping apparatus 1 of the exemplary embodiment is configured to determine that lane change from the traveling lane to the at least one other lane is unsuitable in response to determination that
(I) The continuously travelable distance of the at least one other lane is longer than the continuously travelable distance of the traveling lane of the own vehicle
(II) The deviation distance representing the deviation of the continuously travelable other-lane distance from the continuously travelable own-lane distance is smaller than or equal to the threshold distance

This configuration determines whether lane change from the traveling lane to the at least one other lane makes longer execution of the lane keeping control routine of the own vehicle on a selected other lane included in the at least one other lane. In response to determining that lane change from the traveling lane to the at least one other lane does not make longer execution of the lane keeping control routine of the own vehicle on a selected other lane included in the at least one other lane, this configuration disables outputting of
(I) Information that prompts the driver of the own vehicle to perform a lane change operation from the traveling lane to the at least one other lane
(II) Instruction for instructing the cruise control system 7 to perform the autonomous-driving control task of such lane change

While the illustrative exemplary embodiment of the present disclosure has been described herein, the present disclosure is not limited to the embodiment and its configurations described herein. Specifically, the present disclosure can include various modifications and/or alternatives within the scope of the present disclosure or its equivalent ranges. In addition to various combinations and forms, other combinations and forms including one or more/less elements thereof are also within the inventive principle and scope of the present disclosure.

When the own vehicle operates in the manual driving mode, the lane keeping apparatus 1 of the exemplary embodiment can be configured to cause the notification system 6 to output, to the driver of the own vehicle, information that prompts the driver to perform lane change in response to determination that circumstances that enable the driver to perform lane change safely and securely are established.

For example, the lane keeping apparatus 1 can enable the notification system 6 to output, to the driver of the own vehicle, information that prompts the driver to perform lane change when the own vehicle is traveling on a straight road section with a good view. In contrast, the lane keeping apparatus 1 can disable the notification system 6 from outputting, to the driver of the own vehicle, information that prompts the driver to perform lane change when the own vehicle is traveling on a curved road section with relatively poor view, and enable the notification system 6 to output, to the driver of the own vehicle, information that prompts the driver to perform lane change when the own vehicle, which has passed through the curved road section, enters a straight road section.

The lane keeping apparatus 1 can disable the notification system 6 from outputting, to the driver of the own vehicle, information that prompts the driver to perform lane change when the own vehicle is traveling on, for example, a road section where there is rainfall or a snowfall road section, and enable the notification system 6 to output, to the driver of the own vehicle, information that prompts the driver to perform lane change when the own vehicle has passed through the rainfall road section or the snowfall road.

The continuously travelable distance for at least one lane included in each road segment of each road can be set to a fixed value as static information, or a variable value as dynamic information.

Let us assume that the one or more external servers manage the lane data sets. In this assumption, if a specific lane is temporarily shut off to all traffic due to traffic accident or construction work, the one or more external servers can set the continuously travelable distance for the specific lane to 0 like a passing lane set forth above, making it possible not to prompt the driver to perform lane change to the specific lane.

The one or more external servers can be configured to freely update the continuously travelable distance for at least one lane included in each road segment of each road included in the lane data sets in accordance with traffic situations, and transmit, to the lane keeping apparatus 1, a latest value of the continuously travelable distance for at least one lane included in each road segment of each road included in the lane data sets through the communication networks. This makes it possible to suitably select any of lanes in a traveling road as a traveling lane even if the configuration of the traveling road is changed and/or the traffic situations are temporarily changed due to traffic accident or construction work.

if a specific lane is temporarily shut off to all traffic due to traffic accident or construction work, the continuously travelable distance for the specific lane can be set to a value determined based on a distance from the current position of the own vehicle to the nearest end of the traffic shutoff section. Alternatively, if there is a traffic jam due to the temporary traffic shutoff of the specific lane, the continuously travelable distance for the specific lane can be set to a value determined based on a distance from the current position of the own vehicle to the tail end of the traffic jam.

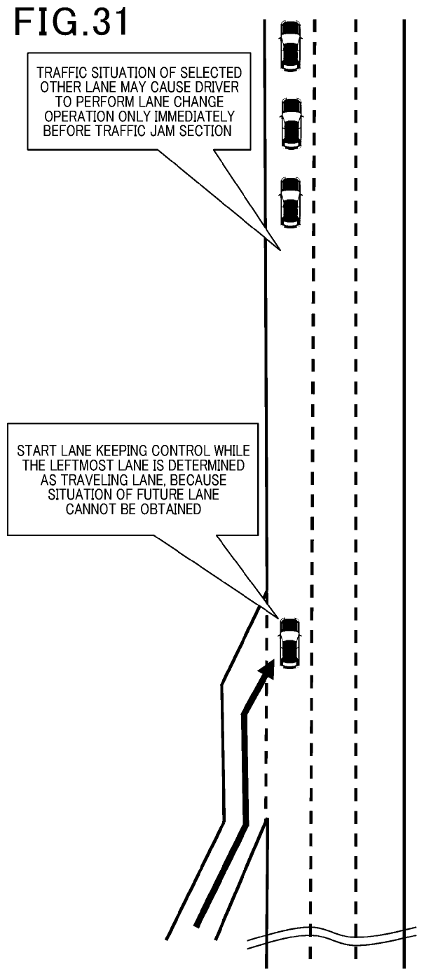

As illustrated in FIG. 31, if there is a traffic jam in the traveling lane of the own vehicle in the forward direction, the driver should perform lane change from the traveling lane to a selected other lane. At that time, the traffic situation of the selected other lane may cause the driver of the own vehicle to perform a lane change operation only immediately before the traffic jam section. This may leave the driver little time for performing a lane change operation.

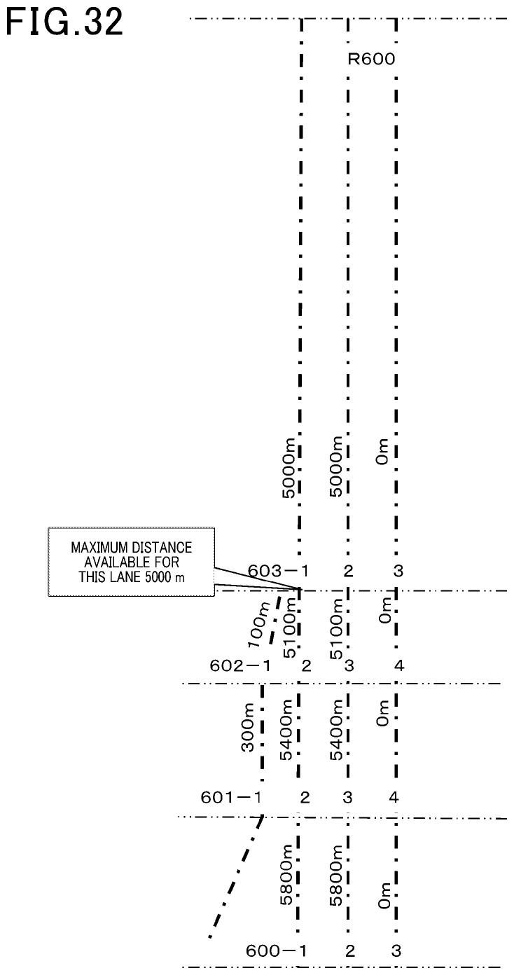

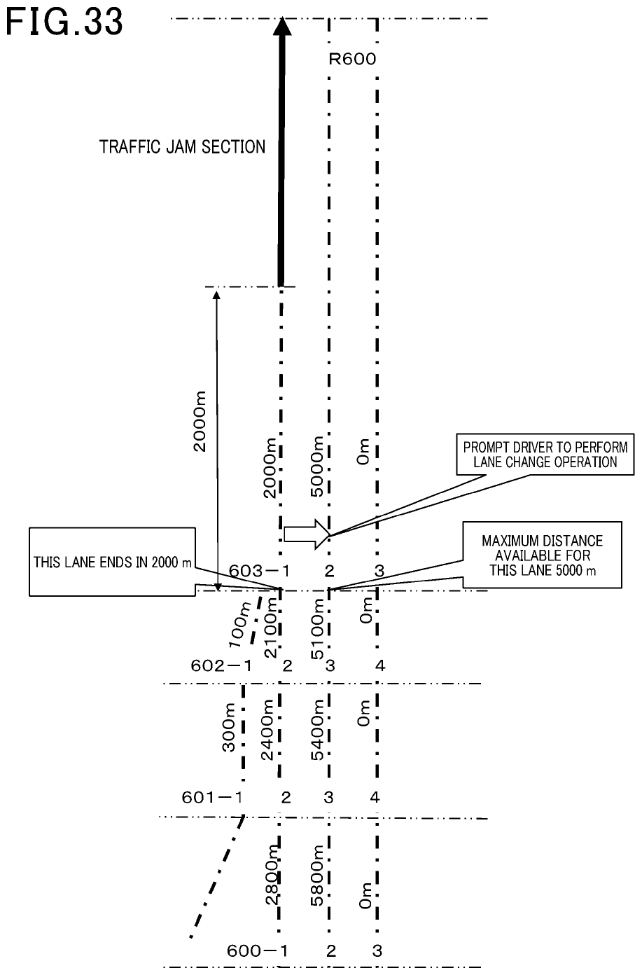

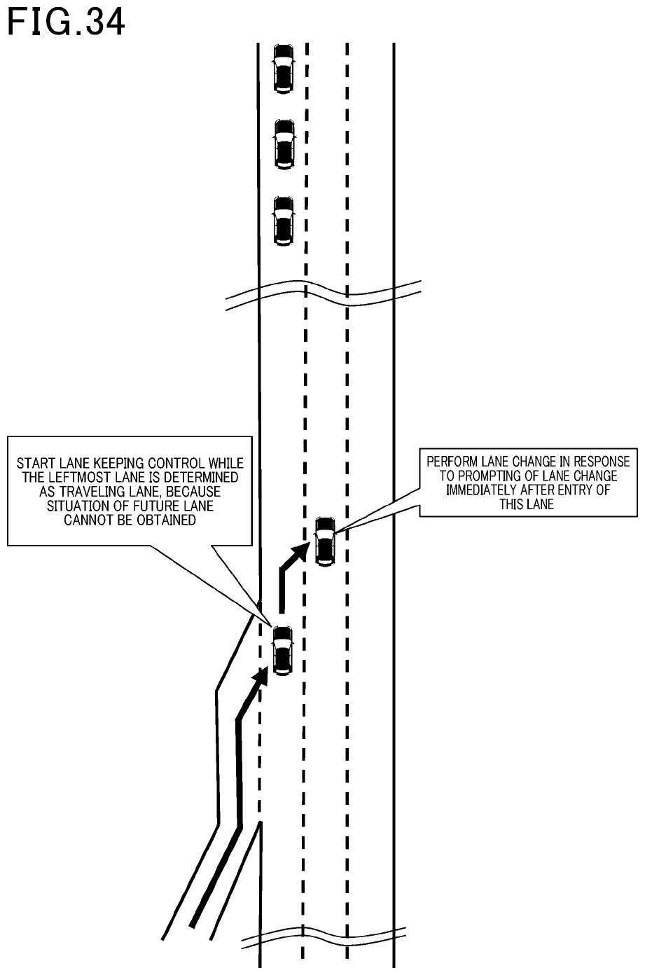

In contrast, the exemplary embodiment can change the continuously travelable distance for any lane included in any road segment from a first value determined in a no traffic-jam situation where there are no traffic jams illustrated in FIG. 32 to a second value determined in a traffic-jam situation where there is a traffic jam illustrated in FIG. 33. This makes it possible to, as illustrated in FIG. 34, prompt the driver of the own vehicle, which has just entered the normal-lane segment 603-1 with the segment number (603), to perform lane change from the normal-lane segment 603-1 to a selected other lane. That is, prompting the driver of the own vehicle to perform a lane change operation from the traveling lane to another lane well in advance of the traffic jam can leave the driver sufficient time for performing a lane change operation.

The above operations described in accordance with FIGS. 31 to 34 are carried out an example case where there is a traffic jam in the traveling lane of the own vehicle in the forward direction, but can be applied to any case where the traveling lane in the forward direction is temporarily shut off to all traffic due to traffic accident or construction work.

The predetermined threshold distance serving as a criterion for determining whether change of the traveling lane of the own vehicle to a selected other lane is suitable can be set to a fixed distance or a variable distance that can vary depending on (i) the type of the traveling road and/or (ii) the type of the traveling lane. The type of the traveling road can be for example classified into a first group of motorways or a second group of general roads. The type of the traveling lane can be for example classified into a first group of passing lanes, a second group of climbing lanes, or a third group of the other lanes.

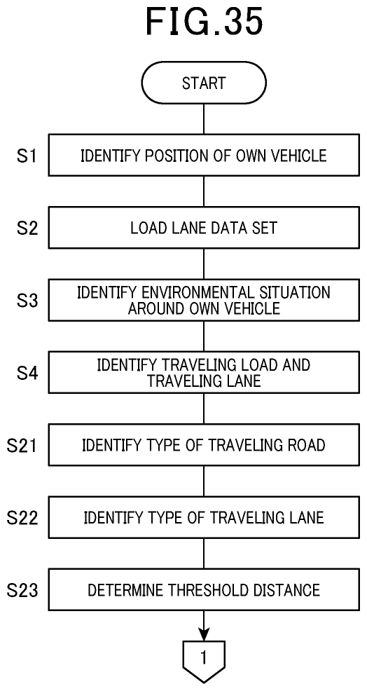

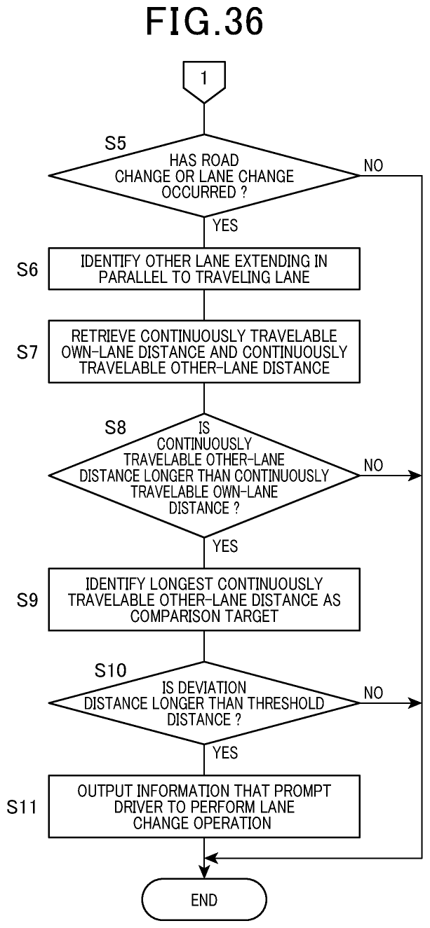

As illustrated in FIGS. 35 and 36, when identifying the traveling road and traveling lane of the own vehicle in step S4, the controller 2 identifies the type of the traveling road in step S21, and identifies the type of the traveling lane in step S22.

Next, the controller 2 determines, as the threshold distance, a selected distance that is linked to the type of the traveling road and the type of the traveling lane in step S23, and thereafter, carries out the operation in step S5 and the subsequent operations.

Changing a predetermined value of the threshold distance to a selected value depending on the type of the traveling road and the type of the traveling lane enables whether lane change from the traveling lane to a selected other lane is suitable to be determined properly based on the type of the traveling road and the type of the traveling lane.

The controller 2 can be configured to identify only the type of the traveling road, and change the predetermined value of the threshold distance to a selected value depending on the type of the traveling road. Similarly, the controller 2 can be configured to identify only the type of the traveling lane, and change the predetermined value of the threshold distance to a selected value depending on the type of the traveling lane.

Let us assume that the traveling road has at least three lanes in each way, so that the traveling road has at least two other lanes in addition to the traveling lane of the own vehicle.

In this assumption, the exemplary embodiment is configured to compare the continuously travelable own-lane distance with each of the at least two continuously travelable other-lane distances.

If drivers should keep to the left side of the road, the own vehicle may perform, within a predetermined period, plural lane changes of (i) changing the traveling lane to the nearest other right lane, and (ii) thereafter changing the changed lane as a new traveling lane to the nearest further right lane. In this case, the controller 2 can be configured to output information indicative of the number of lane changes within the predetermined period or information indicative of a countdown of the remaining number of lane changes.

The exemplary embodiment selects one of the plural continuously travelable other-lane distances, which is the longest, as the comparison target distance, and calculates a deviation distance that represents the deviation of the comparison target distance from the continuously travelable own-lane distance. Then, the exemplary embodiment compares the calculated deviation distance with the predetermined threshold distance to accordingly identify the other lane having the longest continuously travelable other-lane distance as the lane-change destination of the own vehicle from the traveling lane.

Alternatively, the exemplary embodiment can be configured to determine whether there are other lanes; each of the other lanes satisfies the following requirements:

The first requirement is that each of the other lanes has the deviation distances longer than the predetermined threshold distance.

The second requirement is that the difference between the longest continuously travelable distance and the continuously travelable distance of each of the other lanes is longer than a predetermined reference distance.

Upon determining that each of the other lanes satisfies the first and second requirements, the exemplary embodiment can be configured to identify, as the lane-change destination of the own vehicle from the traveling lane, one of the other lanes, which is located nearest to the traveling lane.

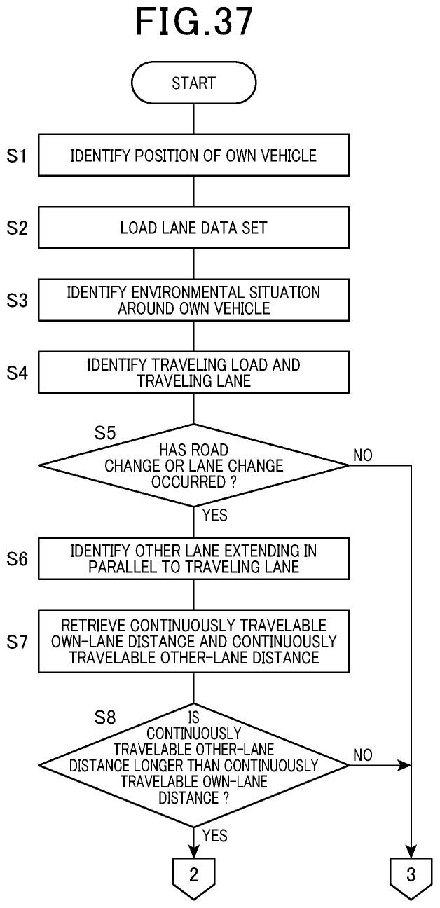

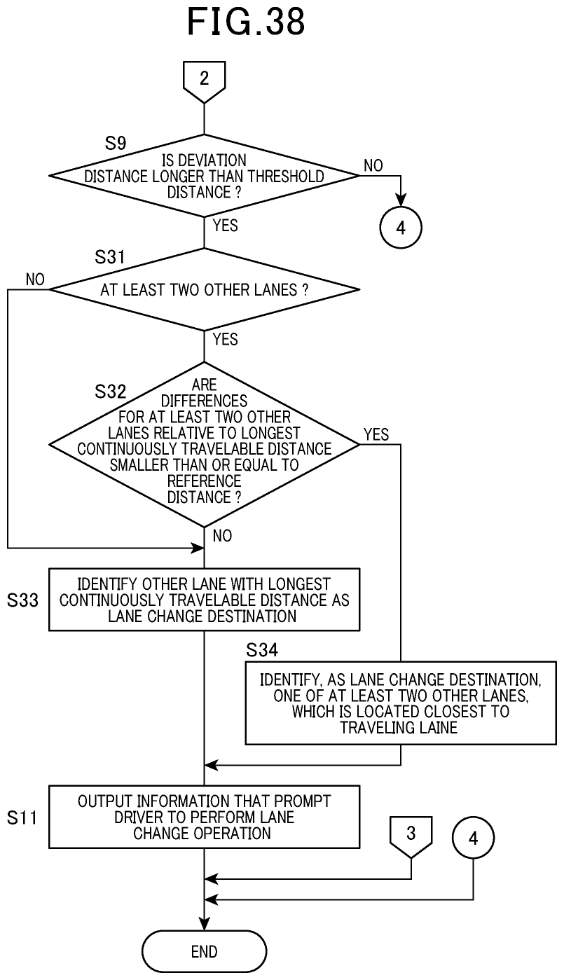

Specifically, as illustrated in FIGS. 37 and 38, upon determining that the continuously travelable other-lane distances of the other lanes, which are longer than the continuously travelable own-lane distance, are present (YES in step S8), the controller 2 can calculate a deviation distance that represents the deviation of each of the continuously travelable other-lane distances from the continuously travelable own-lane distance, and compare the deviation distance for each of the other lanes with the predetermined threshold distance in step S9.

Upon determining that the deviation distances for at least one of the other lanes with the predetermined threshold distance is longer than the predetermined threshold distance (YES in step S9), the controller 2 can determine whether the number of the at least one of the other lanes whose deviation distance is longer than the predetermined threshold distance is at least two in step S31.

Upon determining that the number of the at least one of the other lanes whose deviation distance is longer than the predetermined threshold distance is at least two (YES in step S31), the controller 2 can calculate the difference between the longest continuously travelable distance and the continuously travelable distance of each of the at least two other lanes, and determine whether the difference for each of the at least two other lanes relative to the longest continuously travelable distance is smaller than or equal to the predetermined reference distance in step S32.

Upon determining that the number of the at least one of the other lanes whose deviation distance is longer than the predetermined threshold distance is not at least two (NO in step S31), or upon determining that the differences for all of the at least two other lanes relative to the longest continuously travelable distance are longer than the predetermined reference distance (NO in step S32), the controller 2 can identify, as the lane-change destination of the own vehicle from the traveling lane, the other lane with the longest continuously travelable other-lane distance in step S33. Then, the controller 2 can output, to the notification system 6, an information signal that causes the notification system 6 to output information that prompts the driver of the own vehicle to perform a lane change operation from the traveling lane to the identified other lane with the longest continuously travelable other-lane distance in step S11.

Otherwise, upon determining that the differences for the at least two other lanes relative to the longest continuously travelable distance are smaller than or equal to the predetermined reference distance (YES in step S32), the controller 2 can perform an operation in step S34.

Specifically, the controller 2 can identify, as the lane-change destination of the own vehicle from the traveling lane, one of (i) the longest other lane with the longest continuously travelable distance and (ii) the at least two other lanes, which is located closest to the traveling lane in step S34. Then, the controller 2 can output, to the notification system 6, an information signal that causes the notification system 6 to output information that prompts the driver of the own vehicle to perform a lane change operation from the traveling lane to the identified other lane in step S11.

The exemplary embodiment can perform, based on a lane-change cost for each of the other lanes, a task of subtracting, from the continuously travelable other lane distance of each of the other lanes, a cost-related lane-change distance determined for the corresponding one of the other lanes to accordingly calculate a corrected continuously travelable distance for each of the other lanes. Then, the exemplary embodiment can identify, as the lane-change destination of the own vehicle from the traveling lane, one of the other lanes, which has the longest corrected continuously travelable distance.

The cost-related lane-change distance determined for each of the other lanes can be defined as the produce of
(I) A unit cost-related lane-change distance required for a lane change of the own vehicle from the traveling lane to an adjacent other lane
(II) The number of lane changes required for the own vehicle to have reached the corresponding one of the other lanes from the traveling lane

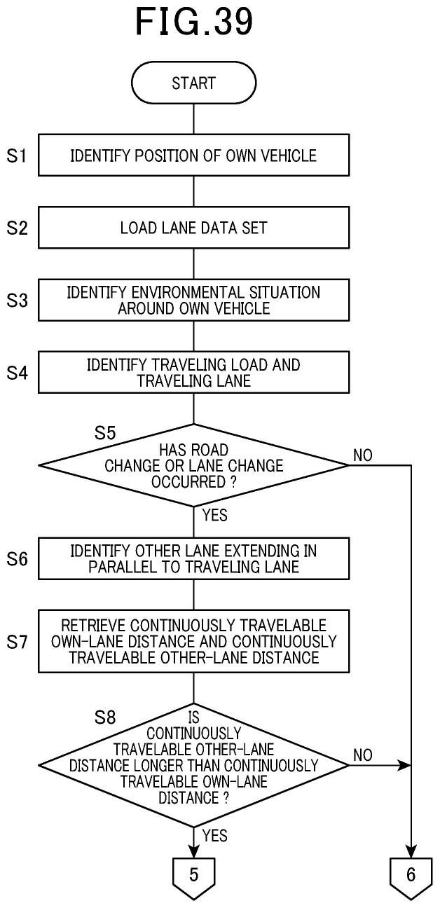

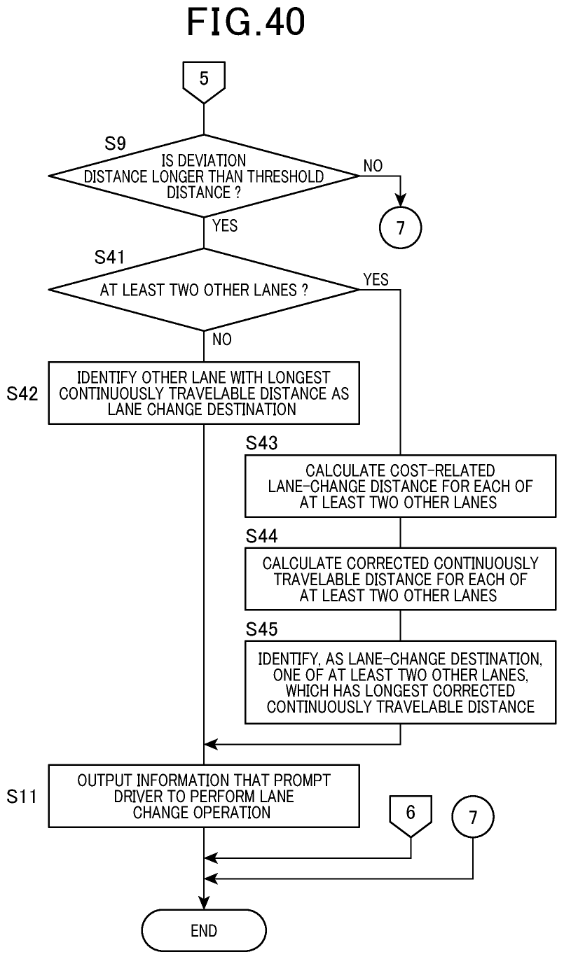

Specifically, as illustrated in FIGS. 39 and 40, upon determining that the continuously travelable other-lane distances of the other lanes, which are longer than the continuously travelable own-lane distance, are present (YES in step S8), the controller 2 can calculate a deviation distance that represents the deviation of each of the continuously travelable other-lane distances from the continuously travelable own-lane distance, and compare the deviation distance for each of the other lanes with the predetermined threshold distance in step S9.

Upon determining that the deviation distance for at least one of the other lanes is longer than the predetermined threshold distance (YES in step S9), the controller 2 can determine whether the number of the at least one of the other lanes whose deviation distance is longer than the predetermined threshold distance is at least two in step S41.

Upon determining that the number of the at least one of the other lanes whose deviation distance is longer than the predetermined threshold distance is not at least two (NO in step S41), the controller 2 can identify, as the lane-change destination of the own vehicle from the traveling lane, the other lane with the longest continuously travelable other-lane distance in step S42. Then, the controller 2 can output, to the notification system 6, an information signal that causes the notification system 6 to output information that prompts the driver of the own vehicle to perform a lane change operation from the traveling lane to the identified other lane with the longest continuously travelable other-lane distance in step S11

Otherwise, upon determining that the number of the at least one of the other lanes whose deviation distance is longer than the predetermined threshold distance is at least two (YES in step S41), the controller 2 can calculate the cost-related lane-change distance determined for each of the at least two other lanes in step S43. Then, the controller 2 can subtract, from the continuously travelable other lane distance of each of the at least two other lanes, the cost-related lane-change distance calculated for the corresponding one of the at least two other lanes to accordingly calculate the corrected continuously travelable distance for each of the at least two other lanes in step S44.

Next, the controller 2 can identify, as the lane-change destination of the own vehicle from the traveling lane, one of the at least two other lanes, which has the longest corrected continuously travelable distance in step S45. Then, the controller 2 can output, to the notification system 6, an information signal that causes the notification system 6 to output information that prompts the driver of the own vehicle to perform a lane change operation from the traveling lane to the identified other lane with the longest corrected continuously travelable other-lane distance in step S11.

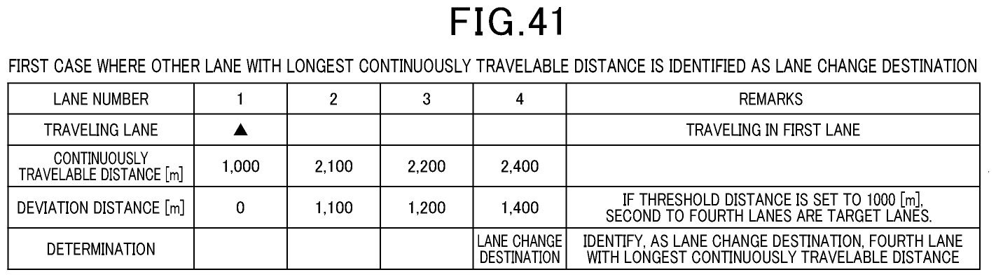

Let us assume that the controller 2 identifies the other lane having the longest continuously travelable other-lane distance as the lane-change destination of the own vehicle from the traveling lane under the situation that the continuously travelable distances of first to fourth lanes of a four-lane road in each way are determined in FIG. 41.

In this assumption, the controller 2 can identify, as the lane-change destination of the own vehicle from the traveling lane, the fourth lane whose continuously travelable distance (2400 m) is the longest in all the first to fourth lanes.

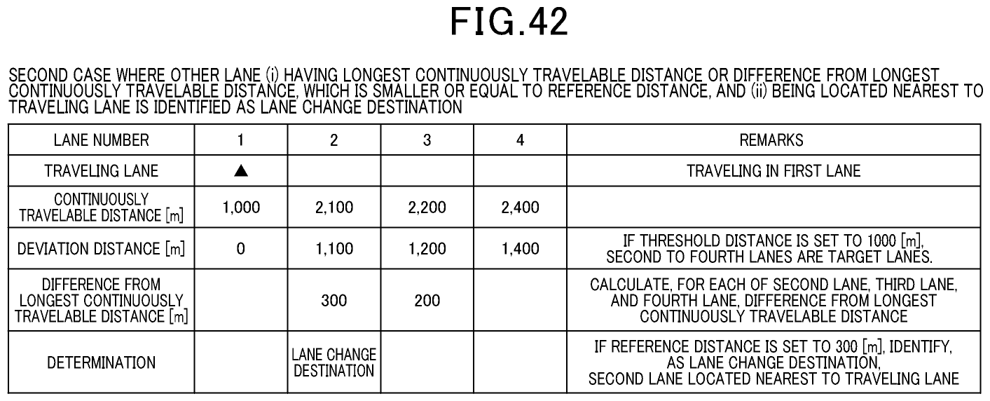

Let us assume that the controller 2 identifies, as the lane-change destination of the own vehicle from the traveling lane, the other lane (i) having the longest continuously travelable distance or a difference from the longest continuously travelable distance, which is smaller than or equal to the predetermined reference distance, and (ii) being located nearest to the traveling lane under the situation that the continuously travelable distances of first to fourth lanes of a four-lane road in each way are determined in FIG. 42.

In this assumption, the controller 2 can identify, as the lane-change destination of the own vehicle from the traveling lane, the second lane located nearest to the traveling lane.

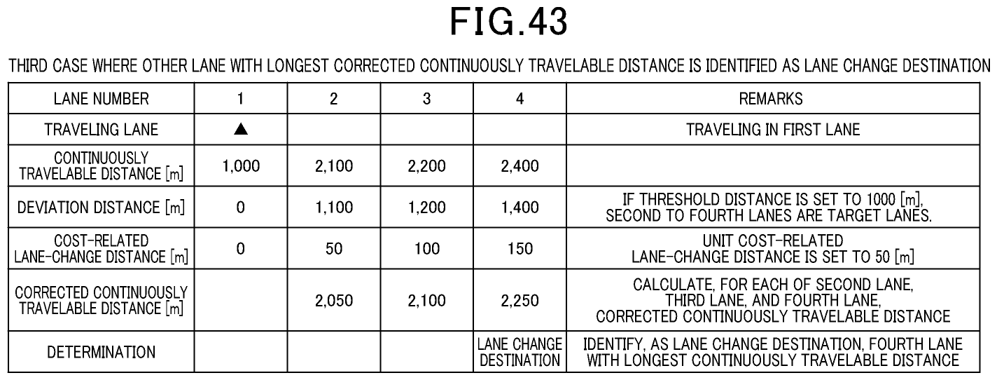

Let us assume that the controller 2 identifies the other lane having the longest corrected continuously travelable other-lane distance as the lane-change destination of the own vehicle from the traveling lane under the situation that the continuously travelable distances of first to fourth lanes of a four-lane road in each way are determined in FIG. 43.

In this assumption, the controller 2 can identify, as the lane-change destination of the own vehicle from the traveling lane, the fourth lane having the corrected continuously travelable distance (2250 m) that is the longest in all the first to fourth lanes.

The exemplary embodiment is configured to determine that change of the traveling lane of the own vehicle to a selected other lane included in the at least one other lane is suitable upon determining that (i) the continuously travelable other-lane distance of at least one other lane is longer than the continuously travelable own-lane distance, and (ii) the deviation distance that represents the deviation of the continuously travelable other-lane distance from the continuously travelable own-lane distance is longer than the predetermined threshold distance. The present disclosure can be configured to determine that change of the traveling lane of the own vehicle to a selected other lane included in the at least one other lane is suitable upon determining that the continuously travelable other-lane distance of at least one other lane is longer than the continuously travelable own-lane distance without determination of whether the deviation distance is longer than the predetermined threshold distance.

The controllers and their control methods described in the present disclosure can be implemented by a dedicated computer including a memory and a processor programmed to perform one or more functions embodied by one or more computer programs.

The controllers and their control methods described in the present disclosure can also be implemented by a dedicated computer including a processor comprised of one or more dedicated hardware logic circuits.

The controllers and their control methods described in the present disclosure can further be implemented by a processor system comprised of a memory, a processor programmed to perform one or more functions embodied by one or more computer programs, and one or more hardware logic circuits.

The one or more programs can be stored in a non-transitory storage medium as instructions to be carried out by a computer or a processor.

1. A lane determination apparatus comprising:
a first retrieving unit configured to retrieve, for each of a plurality of lanes, a continuously travelable distance, the continuously travelable distance for each of the lanes representing a distance for which an own vehicle is able to travel while keeping the corresponding one of the lanes;
a first identifying unit configured to identify:
a road, as a traveling road, on which the own vehicle is traveling; and
one of the lanes, as a traveling lane, in which the own vehicle is traveling;
a first determiner configured to compare a continuously travelable own-lane distance with at least one continuously travelable other-lane distance to accordingly determine whether lane change from the traveling lane to at least one other lane included in the plurality of lanes is suitable, the continuously travelable own-lane distance being the continuously travelable distance of the traveling lane of the own vehicle, the at least one continuously travelable other-lane distance being the continuously travelable distance of the at least one other lane; and
an output unit configured to output information indicative of whether lane change from the traveling lane to the at least one other lane is suitable.

2. The lane determination apparatus according to claim 1, further comprising:
a second identifier configured to identify a position of the own vehicle;
a second retrieving unit configured to retrieve road identification information that enables, from various roads, a road corresponding to the position of the own vehicle to be identified;
a third retrieving unit configured to retrieve lane identification information that enables, from various lanes, a lane corresponding to the position of the own vehicle to be identified; and
a third identifying unit configured to identify an environmental situation around the own vehicle,
wherein:
the first identifying unit is configured to identify the traveling road and the traveling lane of the own vehicle in accordance with the road identification information, the lane identification information, and the environmental situation,
the continuously travelable distance for each of the lanes being defined to correlate with:
a road information item about a road corresponding to the lanes included in the road identification information; and
a lane information item about the corresponding one of the lanes included in the lane identification information.

3. The lane determination apparatus according to claim 2, wherein:
a lane data set is provided for each of the plurality of lanes, the lane data set for each of the plurality of lanes comprising:
the road information item about the road corresponding to the lanes included in the road identification information;
the lane information item about the corresponding one of the lanes; and
the continuously travelable distance for the corresponding one of the lanes; and
the first retrieving unit configured to retrieve, from the lane data set provided for each of the lanes, the continuously travelable distance for the corresponding one of the lanes.

4. The lane determination apparatus according to claim 1, further comprising:
a second determiner configured to determine whether road change has occurred and whether lane change has occurred,
wherein:
the first determiner is configured to compare the continuously travelable own-lane distance with the at least one continuously travelable other-lane distance in response to determination that road change has occurred or determination that lane change has occurred.

5. The lane determination apparatus according to claim 1, wherein:
the first determiner is configured to:
determine whether the at least one continuously travelable other-lane distance is longer than the continuously travelable own-lane distance;
determine whether a deviation distance of the at least one continuously travelable other-lane distance from the continuously travelable own-lane distance is longer than a threshold distance upon determination that the at least one continuously travelable other-lane distance is longer than the continuously travelable own-lane distance; and
determine that lane change from the traveling lane to the at least one other lane is suitable upon determination that the deviation distance of the at least one continuously travelable other-lane distance from the continuously travelable own-lane distance is longer than the threshold distance.

6. The lane determination apparatus according to claim 5, wherein:
the first determiner is configured to determine whether the deviation distance of the at least one continuously travelable other-lane distance from the continuously travelable own-lane distance is longer than a value of the threshold distance, the value of the threshold distance being determined depending on at least one of a type of the traveling road and a type of the traveling lane.

7. The lane determination apparatus according to claim 5, wherein:
when at least two other lanes included in the plurality of other lanes have the respective continuously travelable other-lane distances that are longer than longer than the threshold distance, the first determiner is configured to:
calculate a difference of the continuously travelable other-lane distance of each of the at least two other lanes from the longest continuously travelable distance;
determine whether the difference of the continuously travelable other-lane distance of each of the at least two other lanes from the longest continuously travelable distance is smaller than or equal to a predetermined reference distance;
select, when determining that the difference of the continuously travelable other-lane distance of each of the at least two other lanes from the longest continuously travelable distance is smaller than or equal to the predetermined reference distance, one of the at least two other lanes as a target other lane, the selected target other lane being located nearest to the traveling lane of the own vehicle; and
determine that lane change from the traveling lane to the selected target other lane is suitable.

8. The lane determination apparatus according to claim 5, wherein:
when at least two other lanes included in the plurality of other lanes have the respective continuously travelable other-lane distances that are longer than longer than the threshold distance, the first determiner is configured to:
subtract, from the continuously travelable other-lane distance of each of the at least two other lanes, a cost-related lane-change distance determined for the corresponding one of the at least two other lanes to accordingly calculate a corrected continuously travelable distance for each of the at least two other lanes;
select one of the at least two other lanes as a target other lane, the corrected continuously travelable distance of the selected target other lane being the longest in all the corrected continuously travelable distances of the at least two other lanes; and
determine that lane change from the traveling lane to the selected target other lane is suitable.

9. The lane determination apparatus according to claim 5, wherein:
the first determiner is configured to determine that lane change from the traveling lane to the at least one other lane is unsuitable upon determination that the deviation distance of the at least one continuously travelable other-lane distance from the continuously travelable own-lane distance is smaller than or equal to the threshold distance even if the at least one continuously travelable other-lane distance is longer than the continuously travelable own-lane distance.

10. The lane determination apparatus according to claim 1, wherein:
the lane determination apparatus is configured to operate in cooperation with a notification system that outputs, to a user of the lane determination apparatus, information; and
the output unit is configured to output, to the notification system, the information indicative of whether lane change from the traveling lane to the at least one other lane is suitable.

11. The lane determination apparatus according to claim 1, wherein:
the lane determination apparatus is configured to operate in cooperation with a cruise control system that performs control tasks related to how the own vehicle travels; and
the output unit is configured to output, to the cruise control system, the information indicative of whether lane change from the traveling lane to the at least one other lane is suitable.

12. The lane determination apparatus according to claim 1, wherein:
the first retrieving unit is configured to retrieve, for each of the plurality of lanes, the continuously travelable distance as static information.

13. The lane determination apparatus according to claim 1, wherein:
the first retrieving unit is configured to retrieve, for each of the plurality of lanes, the continuously travelable distance as dynamic information.

14. A lane-change program product for a controller of a lane determination apparatus, the lane-change program product comprising:
a non-transitory computer-readable medium; and
a set of computer program instructions embedded in the computer-readable medium, the instructions causing the controller to:
retrieve, for each of a plurality of lanes, a continuously travelable distance, the continuously travelable distance for each of the lanes representing a distance for which the own vehicle is able to travel while keeping the corresponding one of the lanes;
identify:
a road, as a traveling road, on which the own vehicle is traveling; and
one of the lanes, as a traveling lane, in which the own vehicle is traveling;
compare a continuously travelable own-lane distance with at least one continuously travelable other-lane distance to accordingly determine whether lane change from the traveling lane to at least one other lane included in the plurality of lanes is suitable, the continuously travelable own-lane distance being the continuously travelable distance of the traveling lane of the own vehicle, the at least one continuously travelable other-lane distance being the continuously travelable distance of the at least one other lane; and
output information indicative of whether lane change from the traveling lane to the at least one other lane is suitable.

15. A data structure of a lane data set for at least one lane, the lane data set being usable for a lane determination apparatus for keeping an own vehicle traveling on a traveling lane, the data structure of the lane data set for the at least one lane comprising:
road identification information for identifying a road that includes the at least one lane;
lane identification information for identifying the at least one lane; and
a continuously travelable distance for the at least one lane representing a distance for which the own vehicle is able to travel while keeping the at least one lane,
the continuously travelable distance for the at least one lane being defined to correlate with the road identification information about the road and the lane identification information about the at least one lane.

16. The data structure of a lane data set according to claim 15, wherein:
the road including the at least one lane comprises a plurality of segments, the plurality of segments being defined such that vehicle-travel situations in one of any adjacent pair of the segments of the road and vehicle-travel situations in the other of the adjacent pair of segments of the road are different from one another; and
a value of the continuously travelable distance for each of the plurality of segments included in the at least one lane being determined based on a predetermined distance of the corresponding one of the plurality of segments.
